(19) United States
(12) Patent Application Publication
(10) Pub. No.: US 2015/0178282 A1
(43) Pub. Date: Jun. 25, 2015

(54) FAST AND DYNAMIC TARGETING OF USERS WITH ENGAGING CONTENT

(71) Applicant: Yahoo! Inc., Sunnyvale, CA (US)

(72) Inventors: Dilan Gorur, Mountain View, CA (US); Xing Yi, Milpitas, CA (US); Suju Rajan, Sunnyvale, CA (US)

(73) Assignee: Yahoo! Inc., Sunnyvale, CA (US)

(21) Appl. No.: 14/139,607

(22) Filed: Dec. 23, 2013

(51) Int. Cl. G06F 17/30

(52) U.S. Cl. CPC G06F 17/3053

(57) ABSTRACT

Methods, systems and programming for targeting users with engaging content. In one example, a metric with respect to a piece of content is measured for each of a plurality of users. A first set of users is identified from the plurality of users based on the measured metrics and a threshold. User profiles of the first set of users are obtained. A second set of users is then identified based on the user profiles of the first set of users. The piece of content is provided to the second set of users.

### BACKGROUND

1. Technical Field

The present teaching relates to methods and systems for Internet services. Specifically, the present teaching relates to methods and systems for providing online content.

2. Discussion of Technical Background

The Internet has made it possible for a user to electronically access virtually any content at any time and from any location. With the explosion of information, it has become more and more important to provide users with information that is relevant to the user and not just information in general. Further, as users of today's society rely on the Internet as their source of information, entertainment, and/or social connections, e.g., news, social interaction, movies, music, etc, it is critical to provide users with information they find valuable.

Efforts have been made to attempt to allow users to readily access relevant and on the point content. For example, topical portals have been developed that are more subject matter oriented as compared to generic content gathering systems such as traditional search engines. Example topical portals include portals on finance, sports, news, weather, shopping, music, art, film, etc. Such topical portals allow users to access information related to subject matters that these portals are directed to. Users have to go to different portals to access content of certain subject matter, which is not convenient and not user centric.

Another line of efforts in attempting to enable users to easily access relevant content is via personalization, which aims at understanding each user's individual likings/interests/preferences so that an individualized user profile for each user can be set up and can be used to select content that matches a user's interests. The underlying goal is to meet the minds of users in terms of content consumption. User profiles traditionally are constructed based on users' declared interests and/or inferred from, e.g., users' demographics. There have also been systems that identify users' interests based on observations made on users' interactions with content. A typical example of such user interaction with content is click through rate (CTR).

These traditional approaches have various shortcomings. For example, user interests are detected in isolated application settings so that user profiling in individual applications cannot capture a broad range of the overall interests of a user. Such a traditional approach to user profiling leads to a fragmented representation of user interests without a coherent understanding of the users' preferences. Because profiles of the same user derived from different application settings are often grounded with respect to the specifics of the applications, it is also difficult to integrate them to generate a more coherent profile that better represent the user's interests.

User activities directed to content are traditionally observed and used to estimate or infer users' interests. CTR is the most commonly used measure to estimate users' interests. However, CTR is no longer adequate to capture users' interests particularly given that different types of activities that a user may perform on different types of devices may also reflect or implicate user's interests. For example, activities such as browsing a list of content items, sharing a content item on social media or email etc, could also imply user interests.

Yet another line of effort to allow users to access relevant content is to pool content that may be interesting to users. Given the explosion of information on the Internet, it is not likely, even if possible, to evaluate all content accessible via the Internet whenever there is a need to select content relevant to a particular user. Thus, realistically, it is needed to identify a subset or a pool of the Internet content based on some criteria so that content can be selected from this pool and recommended to users based on their interests for consumption.

Conventional approaches to creating such a subset of content are application centric. Each application carves out its own subset of content in a manner that is specific to the application. For example, Amazon.com may have a content pool related to products and information associated thereof created/updated based on information related to its own users and/or interests of such users exhibited when they interact with Amazon.com. Facebook also has its own subset of content, generated in a manner not only specific to Facebook but also based on user interests exhibited while they are active on Facebook. As a user may be active in different applications (e.g., Amazon.com and Facebook) and with each application, they likely exhibit only part of their overall interests in connection with the nature of the application. Given that, each application can usually gain understanding, at best, of partial interests of users, making it difficult to develop a subset of content that can be used to serve a broader range of users' interests.

There is a need for improvements over the conventional approaches to personalizing content recommendation.

### SUMMARY

The present teaching relates to methods, systems, and programming for Internet services, Particularly, the present teaching is directed to methods, systems, and programming for providing online content.

In one example, a method, implemented on at least one machine each having at least one processor, storage, and a communication platform connected to a network for providing content is presented. A metric with respect to a piece of content is measured for each of a plurality of users. A first set of users is identified from the plurality of users based on the measured metrics and a threshold. User profiles of the first set of users are obtained. A second set of users is then identified based on the user profiles of the first set of users. The piece of content is provided to the second set of users.

In another example, a method, implemented on at least one machine each having at least one processor, storage, and a communication platform connected to a network for providing content is presented. A first piece of content in which a target user is interested is first identified. A metric with respect to the first piece of content is measured for each of a plurality of users. A set of users is identified from the plurality of users based on the measured metrics and a threshold. User profiles of the set of users are obtained. A second piece of content is determined based on the user profiles of the set of users. The second piece of content is provided to the target user.

In a different example, a system having at least one processor, storage, and a communication platform for providing content is presented. The system includes a user engagement measurement module, a user identifying module, a user profile building module, a user profile matching module, and a content recommendation module. The user engagement measurement module is implemented by the at least one processor and configured to measure a metric with respect to a piece of content for each of a plurality of users. The user identifying module is implemented by the at least one processor and configured to identify a first set of users from the plurality of users based on the measured metrics and a threshold. The user profile building module is implemented by the at least one processor and configured to obtain user profiles of the first set of users. The user profile matching module is implemented by the at least one processor and configured to identify a second set of users based on the user profiles of the first set of users. The content recommendation module is implemented by the at least one processor and configured to provide the piece of content to the second set of users.

Other concepts relate to software for providing content. A software product, in accord with this concept, includes at least one non-transitory machine-readable medium and information carried by the medium. The information carried by the medium may be executable program code data regarding parameters in association with a request or operational parameters, such as information related to a user, a request, or a social group, etc.

In one example, a non-transitory machine readable medium having information recorded thereon for providing content is presented. The recorded information, when read by the machine, causes the machine to perform a series of steps. A metric with respect to a piece of content is measured for each of a plurality of users. A first set of users is identified from the plurality of users based on the measured metrics and a threshold. User profiles of the first set of users are obtained. A second set of users is then identified based on the user profiles of the first set of users. The piece of content is provided to the second set of users.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary system diagram for personalized content recommendation, according to an embodiment of the present teaching;

FIG. 2 is a flowchart of an exemplary process for personalized content recommendation, according to an embodiment of the present teaching;

FIG. 3 illustrates exemplary types of context information;

FIG. 4 depicts an exemplary diagram of a content pool generation/update unit, according to an embodiment of the present teaching;

FIG. 5 is a flowchart of an exemplary process of creating a content pool, according to an embodiment of the present teaching;

FIG. 6 is a flowchart of an exemplary process for updating a content pool, according to an embodiment of the present teaching;

FIG. 7 depicts an exemplary diagram of a user understanding unit, according to an embodiment of the present teaching;

FIG. 8 is a flowchart of an exemplary process for generating a baseline interest profile, according to an embodiment of the present teaching;

FIG. 9 is a flowchart of an exemplary process for generating a personalized user profile, according to an embodiment of the present teaching;

FIG. 10 depicts an exemplary system diagram for a content ranking unit, according to an embodiment of the present teaching;

FIG. 11 is a flowchart of an exemplary process for the content ranking unit, according to an embodiment of the present teaching;

FIG. 12 depicts an exemplary scheme of the present teaching, according to an embodiment of the present teaching;

FIG. 13 shows exemplary types of per-content non-clicking engagement metrics;

FIG. 14 depicts an exemplary diagram in which per-content user engagement events are ordered by timestamp and per-event user engagement levels are plotted on a timeline;

FIG. 15 is an exemplary diagram of a system for providing engaging content to target users, according to an embodiment of the present teaching;

FIG. 16 is a flowchart of an exemplary process of the scheme shown in FIG. 12, according to an embodiment of the present teaching;

FIG. 17 is a flowchart of another exemplary process of the scheme shown in FIG. 12, according to an embodiment of the present teaching;

FIG. 18 depicts another exemplary scheme of the present teaching, according to an embodiment of the present teaching;

FIG. 19 is a flowchart of an exemplary process of the scheme shown in FIG. 18, according to an embodiment of the present teaching;

FIGS. 20-22 depict exemplary embodiments of a networked environment in which the present teaching is applied, according to different embodiments of the present teaching;

FIG. 23 depicts a general mobile device architecture on which the present teaching can be implemented; and

FIG. 24 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching relates to personalizing on-line content recommendations to a user. Particularly, the present teaching relates to a system, method, and/or programs for personalized content recommendation that addresses the shortcomings associated the conventional content recommendation solutions in personalization, content pooling, and recommending personalized content.

With regard to personalization, the present teaching identifies a user's interests with respect to a universal interest space, defined via known concept archives such as Wikipedia and/or content taxonomy. Using such a universal interest space, interests of users, exhibited in different applications and via different platforms, can be used to establish a general population's profile as a baseline against which individual user's interests and levels thereof can be determined. For example, users active in a third party application such as Facebook or Twitter and the interests that such users exhibited in these third party applications can be all mapped to the universal interest space and then used to compute a baseline interest profile of the general population. Specifically, each user's interests observed with respect to each document covering certain subject matters or concepts can be mapped to, e.g., Wikipedia or certain content taxonomy. A high dimensional vector can be constructed based on the universal interest space in which each attribute of the vector corresponds to a concept in the universal space and the value of the attribute may corresponds to an evaluation of the user's interest in this particular concept. The general baseline interest profile can be derived based on all vectors represent the population. Each vector representing an individual can be normalized against the baseline interest profile so that the relative level of interests of the user with respect to the concepts in the universal interest space can be determined. This enables better understanding of the level of interests of the user in different subject matters with respect to a more general population and result in enhanced personalization for content recommendation. Rather than characterizing users' interests merely according to proprietary content taxonomy, as is often done in the prior art, the present teaching leverages public concept archives, such as Wikipedia or online encyclopedia, to define a universal interest space in order to profile a user's interests in a more coherent manner. Such a high dimensional vector captures the entire interest space of every user, making person-to-person comparison as to personal interests more effective. Profiling a user and in this manner also leads to efficient identification of users who share similar interests. In addition, content may also be characterized in the same universal interest space, e.g., a high dimensional vector against the concepts in the universal interest space can also be constructed with values in the vector indicating whether the content covers each of the concepts in the universal interest space. By characterizing users and content in the same space in a coherent way, the affinity between a user and a piece of content can be determined via, e.g., a dot product of the vector for the user and the vector for the content.

The present teaching also leverages short term interests to better understand long term interests of users. Short term interests can be observed via user online activities and used in online content recommendation, the more persistent long term interests of a user can help to improve content recommendation quality in a more robust manner and, hence, user retention rate. The present teaching discloses discovery of long term interests as well as short term interests.

To improve personalization, the present teaching also discloses ways to improve the ability to estimate a user's interest based on a variety of user activities. This is especially useful because meaningful user activities often occur in different settings, on different devices, and in different operation modes. Through such different user activities, user engagement to content can be measured to infer users' interests. Traditionally, clicks and click through rate (CTR) have been used to estimate users' intent and infer users' interests. CTR is simply not adequate in today's world. Users may dwell on a certain portion of the content, the dwell may be for different lengths of time, users may scroll along the content and may dwell on a specific portion of the content for some length of time, users may scroll down at different speeds, users may change such speed near certain portions of content, users may skip certain portion of content, etc. All such activities may have implications as to users' engagement to content. Such engagement can be utilized to infer or estimate a user's interests. The present teaching leverages a variety of user activities that may occur across different device types in different settings to achieve better estimation of users' engagement in order to enhance the ability of capturing a user's interests in a more reliable manner.

Another aspect of the present teaching with regard to personalization is its ability to explore unknown interests of a user by generating probing content. Traditionally, user profiling is based on either user provided information (e.g., declared interests) or passively observed past information such as the content that the user has viewed, reactions to such content, etc. Such prior art schemes can lead to a personalization bubble where only interests that the user revealed can be used for content recommendation. Because of that, the only user activities that can be observed are directed to such known interests, impeding the ability to understand the overall interest of a user. This is especially so considering the fact that users often exhibit different interests (mostly partial interests) in different application settings. The present teaching discloses ways to generate probing content with concepts that is currently not recognized as one of the user's interests in order to explore the user's unknown interests. Such probing content is selected and recommended to the user and user activities directed to the probing content can then be analyzed to estimate whether the user has other interests. The selection of such probing content may be based on a user's current known interests by, e.g., extrapolating the user's current interests. For example, for some known interests of the user (e.g., the short term interests at the moment), some probing concepts in the universal interest space, for which the user has not exhibited interests in the past, may be selected according to some criteria (e.g., within a certain distance from the user's current known interest in a taxonomy tree) and content related to such probing concepts may then be selected and recommended to the user. Another way to identify probing concept (corresponding to unknown interest of the user) may be through the user's cohorts. For instance, a user may share certain interests with his/her cohorts but some members of the circle may have some interests that the user has never exhibited before. Such un-shared interests with cohorts may be selected as probing unknown interests for the user and content related to such probing unknown interests may then be selected as probing content to be recommended to the user. In this manner, the present teaching discloses a scheme by which a user's interests can be continually probed and understood to improve the quality of personalization. Such managed probing can also be combined with random selection of probing content to allow discovery of unknown interests of the users who are far removed from the user's current known interests.

A second aspect of recommending quality personalized content is to build a content pool with quality content that covers subject matters interesting to users. Content in the content pool can be rated in terms of the subject and/or the performance of the content itself. For example, content can be characterized in terms of concepts it discloses and such a characterization may be generated with respect to the universal interest space, e.g., defined via concept archive(s) such as content taxonomy and/or Wikipedia and/or online encyclopedia, as discussed above. For example, each piece of content can be characterized via a high dimensional vector with each attribute of the vector corresponding to a concept in the interest universe and the value of the attribute indicates whether and/or to what degree the content covers the concept. When a piece of content is characterized in the same universal interest space as that for user's profile, the affinity between the content and a user profile can be efficiently determined.

Each piece of content in the content pool can also be individually characterized in terms of other criteria. For example, performance related measures, such as popularity of the content, may be used to describe the content. Performance related characterizations of content may be used in both selecting content to be incorporated into the content pool as well as selecting content already in the content pool for recommendation of personalized content for specific users. Such performance oriented characterizations of each piece of content may change over time and can be assessed periodically and can be done based on users' activities. Content pool also changes over time based on various reasons, such as content performance, change in users' interests, etc. Dynamically changed performance characterization of content in the content pool may also be evaluated periodically or dynamically based on performance measures of the content so that the content pool can be adjusted over time, i.e., by removing low performance content pieces, adding new content with good performance, or updating content.

To grow the content pool, the present teaching discloses ways to continually discover both new content and new content sources from which interesting content may be accessed, evaluated, and incorporated into the content pool. New content may be discovered dynamically via accessing information from third party applications which users use and exhibit various interests. Examples of such third party applications include Facebook, Twitter, Microblogs, or YouTube. New content may also be added to the content pool when some new interest or an increased level of interests in some subject matter emerges or is predicted based on the occurrence of certain (spontaneous) events. One example is the content about the life of Pope Benedict, which in general may not be a topic of interests to most users but likely will be in light of the surprising announcement of Pope Benedict's resignation. Such dynamic adjustment to the content pool aims at covering a dynamic (and likely growing) range of interests of users, including those that are, e.g., exhibited by users in different settings or applications or predicted in light of context information. Such newly discovered content may then be evaluated before it can be selected to be added to the content pool.

Certain content in the content pool, e.g., journals or news, need to be updated over time. Conventional solutions usually update such content periodically based on a fixed schedule. The present teaching discloses the scheme of dynamically determining the pace of updating content in the content pool based on a variety of factors. Content update may be affected by context information. For example, the frequency at which a piece of content scheduled to be updated may be every 2 hours, but this frequency can be dynamically adjusted according to, e.g., an explosive event such as an earthquake. As another example, content from a social group on Facebook devoted to Catholicism may normally be updated daily. When Pope Benedict's resignation made the news, the content from that social group may be updated every hour so that interested users can keep track of discussions from members of this social group. In addition, whenever there are newly identified content sources, it can be scheduled to update the content pool by, e.g., crawling the content from the new sources, processing the crawled content, evaluating the crawled content, and selecting quality new content to be incorporated into the content pool. Such a dynamically updated content pool aims at growing in compatible with the dynamically changing users' interests in order to facilitate quality personalized content recommendation.

Another key to quality personalized content recommendation is the aspect of identifying quality content that meets the interests of a user for recommendation. Previous solutions often emphasize mere relevance of the content to the user when selecting content for recommendation. In addition, traditional relevance based content recommendation was mostly based on short term interests of the user. This not only leads to a content recommendation bubble, i.e., known short interests cause recommendations limited to the short term interests and reactions to such short term interests centric recommendations cycle back to the short term interests that start the process. This bubble makes it difficult to come out of the circle to recommend content that can serve not only the overall interests but also long term interests of users. The present teaching combines relevance with performance of the content so that not only relevant but also quality content can be selected and recommended to users in a multi-stage ranking system.

In addition, to identify recommended content that can serve a broad range of interests of a user, the present teaching relies on both short term and long term interests of the user to identify user-content affinity in order to select content that meets a broader range of users' interests to be recommended to the user.

In content recommendation, monetizing content such as advertisements are usually also selected as part of the recommended content to a user. Traditional approaches often select ads based on content in which the ads are to be inserted. Some traditional approaches also rely on user input such as queries to estimate what ads likely can maximize the economic return. These approaches select ads by matching the taxonomy of the query or the content retrieved based on the query with the content taxonomy of the ads. However, content taxonomy is commonly known not to correspond with advertisement taxonomy, which advertisers use to target at certain audience. As such, selecting ads based on content taxonomy does not serve to maximize the economic return of the ads to be inserted into content and recommended to users.

Yet another aspect of personalized content recommendation of the present teaching relates to recommending probing content that is identified by extrapolating the currently known user interests. Traditional approaches rely on selecting either random content beyond the currently known user interests or content that has certain performance such as a high level of click activities. Random selection of probing content presents a low possibility to discover a user's unknown interests. Identifying probing content by choosing content for which a higher level of activities are observed is also problematic because there can be many pieces of content that a user may potentially be interested but there is a low level of activities associated therewith. The present teaching discloses ways to identify probing content by extrapolating the currently known interest with the flexibility of how far removed from the currently known interests. This approach also incorporates the mechanism to identify quality probing content so that there is an enhanced likelihood to discover a user's unknown interests. The focus of interests at any moment can be used as an anchor interest based on which probing interests (which are not known to be interests of the user) can be extrapolated from the anchor interests and probing content can be selected based on the probing interests and recommended to the user together with the content of the anchor interests. Probing interests/content may also be determined based on other considerations such as locale, time, or device type. In this way, the disclosed personalized content recommendation system can continually explore and discover unknown interests of a user to understand better the overall interests of the user in order to expand the scope of service.

Additional novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

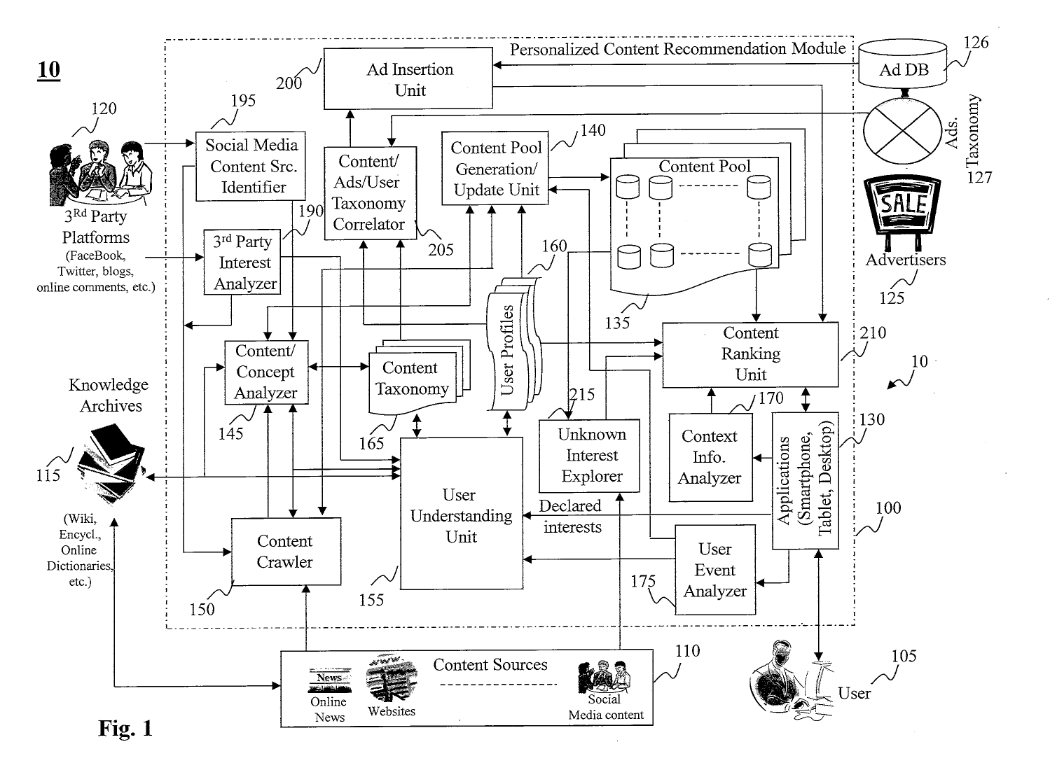

FIG. 1 depicts an exemplary system diagram 10 for personalized content recommendation to a user 105, according to an embodiment of the present teaching. System 10 comprises a personalized content recommendation module 100, which comprises numerous sub modules, content sources 110, knowledge archives 115, third party platforms 120, and advertisers 125 with advertisement taxonomy 127 and advertisement database 126. Content sources 110 may be any source of on-line content such as on-line news, published papers, blogs, on-line tabloids, magazines, audio content, image content, and video content. It may be content from content provider such as Yahoo! Finance, Yahoo! Sports, CNN, and ESPN. It may be multi-media content or text or any other form of content comprised of website content, social media content, such as Facebook, Twitter, Reddit, etc., or any other content rich provider. It may be licensed content from providers such AP and Reuters. It may also be content crawled and indexed from various sources on the Internet. Content sources 110 provide a vast array of content to the personalized content recommendation module 100 of system 10.

Knowledge archives 115 may be an on-line encyclopedia such as Wikipedia or indexing system such as an on-line dictionary. On-line concept archives 115 may be used for its content as well as its categorization or indexing systems. Knowledge archives 115 provide extensive classification system to assist with the classification of both the user's 105 preferences as well as classification of content. Knowledge concept archives, such as Wikipedia may have hundreds of thousands to millions of classifications and sub-classifications. A classification is used to show the hierarchy of the category. Classifications serve two main purposes. First they help the system understand how one category relates to another category and second, they help the system maneuver between higher levels on the hierarchy without having to move up and down the subcategories. The categories or classification structure found in knowledge archives 115 is used for multidimensional content vectors as well as multidimensional user profile vectors which are utilized by personalized content recommendation module 100 to match personalized content to a user 105. Third party platforms 120 maybe any third party applications including but not limited to social networking sites like Facebook, Twitter, LinkedIn, Google+, etc. It may include third party mail servers such as GMail or Bing Search. Third party platforms 120 provide both a source of content as well as insight into a user's personal preferences and behaviors.

Advertisers 125 are coupled with the ad content database 126 as well as an advertisement classification system or advertisement taxonomy 127 intended for classified advertisement content. Advertisers 125 may provide streaming content, static content, and sponsored content. Advertising content may be placed at any location on a personalized content page and may be presented both as part of a content stream as well as a standalone advertisement, placed strategically around or within the content stream.

Personalized content recommendation module 100 comprises applications 130, content pool 135, content pool generation/update unit 140, concept/content analyzer 145, content crawler 150, unknown interest explorer 215, user understanding unit 155, user profiles 160, content taxonomy 165, context information analyzer 170, user event analyzer 175, third party interest analyzer 190, social media content source identifier 195, advertisement insertion unit 200 and content/advertisement/taxonomy correlator 205. These components are connected to achieve personalization, content pooling, and recommending personalized content to a user. For example, the content ranking unit 210 works in connection with context information analyzer 170, the unknown interest explorer 215, and the ad insertion unit 200 to generate personalized content to be recommended to a user with personalized ads or probing content inserted. To achieve personalization, the user understanding unit 155 works in connection with a variety of components to dynamically and continuously update the user profiles 160, including content taxonomy 165, the knowledge archives 115, user event analyzer 175, and the third party interest analyzer 190. Various components are connected to continuously maintain a content pool, including the content pool generation/update unit 140, user event analyzer 175, social media content source identifier 195, content/concept analyzer 145, content crawler 150, the content taxonomy 165, as well as user profiles 160.

Personalized content recommendation module 100 is triggered when user 105 engages with system 10 through applications 130, Applications 130 may receive information in the form of a user id, cookies, log in information from user 105 via some form of computing device, User 105 may access system 10 via a wired or wireless device and may be stationary or mobile, User 105 may interface with the applications 130 on a tablet, a Smartphone, a laptop, a desktop or any other computing device which may be embedded in devices such as watches, eyeglasses, or vehicles. In addition to receiving insights from the user 105 about what information the user 105 might be interested, applications 130 provides information to user 105 in the form of personalized content stream. User insights might be user search terms entered to the system, declared interests, user clicks on a particular article or subject, user dwell time or scroll over of particular content, user skips with respect to some content, etc. User insights may be a user indication of a like, a share, or a forward action on a social networking site, such as Facebook, or even peripheral activities such as print or scan of certain content. All of these user insights or events are utilized by the personalized content recommendation module 100 to locate and customize content to be presented to user 105. User insights received via applications 130 are used to update personalized profiles for users which may be stored in user profiles 160. User profiles 160 may be database or a series of databases used to store personalized user information on all the users of system 10. User profiles 160 may be a flat or relational database and may be stored in one or more locations. Such user insights may also be used to determine how to dynamically update the content in the content pool 135.

A specific user event received via applications 130 is passed along to user event analyzer 175, which analyzes the user event information and feeds the analysis result with event data to the user understanding unit 155 and/or the content pool generation/update unit 140. Based on such user event information, the user understanding unit 155 estimates short term interests of the user and/or infer user's long term interests based on behaviors exhibited by user 105 over long or repetitive periods. For example, a long term interest may be a general interest in sports, where as a short term interest may be related to a unique sports event, such as the Super Bowl at a particular time. Over time, a user's long term interest may be estimated by analyzing repeated user events. A user who, during every engagement with system 10, regularly selects content related to the stock market may be considered as having a long term interest in finances. In this case, system 10 accordingly, may determine that personalized content for user 105 should contain content related to finance. Contrastingly, short term interest may be determined based on user events which may occur frequently over a short period, but which is not something the user 105 is interested in in the long term. For example, a short term interest may reflect the momentary interest of a user which may be triggered by something the user saw in the content but such an interest may not persist over time. Both short and long term interest are important in terms of identifying content that meets the desire of the user 105, but need to be managed separately because of the difference in their nature as well as how they influence the user.

In some embodiments, short term interests of a user may be analyzed to predict the user's long term interests. To retain a user, it is important to understand the user's persistent or long term interests. By identifying user 105's short term interest and providing him/her with a quality personalized experience, system 10 may convert an occasional user into a long term user. Additionally, short term interest may trend into long term interest and vice versa. The user understanding unit 155 provides the capability of estimating both short and long term interests.

The user understanding unit 155 gathers user information from multiple sources, including all the user's events, and creates one or more multidimensional personalization vectors. In some embodiments, the user understanding unit 155 receives inferred characteristics about the user 105 based on the user events, such as the content he/she views, self-declared interests, attributes or characteristics, user activities, and/or events from third party platforms. In an embodiment, the user understanding unit 155 receives inputs from social media content source identifier 195. Social media content source identifier 195 relies on user 105's social media content to personalize the user's profile. By analyzing the user's social media pages, likes, shares, etc, social media content source identifier 195 provides information for user understanding unit 155. The social media content source identifier 195 is capable of recognizing new content sources by identifying, e.g., quality curators on social media platforms such as Twitter, Facebook, or blogs, and enables the personalized content recommendation module 100 to discover new content sources from where quality content can be added to the content pool 135. The information generated by social media content source identifier 195 may be sent to a content/concept analyzer 145 and then mapped to specific category or classification based on content taxonomy 165 as well as a knowledge archives 115 classification system.

The third party interest analyzer 190 leverages information from other third party platforms about users active on such third party platforms, their interests, as well as content these third party users to enhance the performance of the user understanding unit 155. For example, when information about a large user population can be accessed from one or more third party platforms, the user understanding unit 155 can rely on data about a large population to establish a baseline interest profile to make the estimation of the interests of individual users more precise and reliable, e.g., by comparing interest data with respect to a particular user with the baseline interest profile which will capture the user's interests with a high level of certainty.

When new content is identified from content source 110 or third party platforms 120, it is processed and its concepts are analyzed. The concepts can be mapped to one or more categories in the content taxonomy 165 and the knowledge archives 115. The content taxonomy 165 is an organized structure of concepts or categories of concepts and it may contain a few hundred classifications of a few thousand. The knowledge archives 115 may provide millions of concepts, which may or may not be structures in a similar manner as the content taxonomy 165. Such content taxonomy and knowledge archives may serve as a universal interest space. Concepts estimated from the content can be mapped to a universal interest space and a high dimensional vector can be constructed for each piece of content and used to characterize the content. Similarly, for each user, a personal interest profile may also be constructed, mapping the user's interests, characterized as concepts, to the universal interest space so that a high dimensional vector can be constructed with the user's interests levels populated in the vector.

Content pool 135 may be a general content pool with content to be used to serve all users. The content pool 135 may also be structured so that it may have personalized content pool for each user. In this case, content in the content pool is generated and retained with respect to each individual user. The content pool may also be organized as a tiered system with both the general content pool and personalized individual content pools for different users. For example, in each content pool for a user, the content itself may not be physically present but is operational via links, pointers, or indices which provide references to where the actual content is stored in the general content pool.

Content pool 135 is dynamically updated by content pool generation/update module 140. Content in the content pool comes and go and decisions are made based on the dynamic information of the users, the content itself, as well as other types of information. For example, when the performance of content deteriorates, e.g., low level of interests exhibited from users, the content pool generation/update unit 140 may decide to purge it from the content pool. When content becomes stale or outdated, it may also be removed from the content pool. When there is a newly detected interest from a user, the content pool generation/update unit 140 may fetch new content aligning with the newly discovered interests. User events may be an important source of making observations as to content performance and user interest dynamics. User activities are analyzed by the user event analyzer 175 and such Information is sent to the content pool generation/update unit 140. When fetching new content, the content pool generation/update unit 140 invokes the content crawler 150 to gather new content, which is then analyzed by the content/concept analyzer 145, then evaluated by the content pool generation/update unit 140 as to its quality and performance before it is decided whether it will be included in the content pool or not. Content may be removed from content pool 135 because it is no longer relevant, because other users are not considering it to be of high quality or because it is no longer timely. As content is constantly changing and updating content pool 135 is constantly changing and updating providing user 105 with a potential source for high quality, timely personalized content.

In addition to content, personalized content recommendation module 100 provides for targeted or personalized advertisement content from advertisers 125. Advertisement database 126 houses advertising content to be inserted into a user's content stream. Advertising content from ad database 126 is inserted into the content stream via Content ranking unit 210. The personalized selection of advertising content can be based on the user's profile. Content/advertisement/user taxonomy correlator 205 may re-project or map a separate advertisement taxonomy 127 to the taxonomy associated with the user profiles 160. Content/advertisement/user taxonomy correlator 205 may apply a straight mapping or may apply some intelligent algorithm to the re-projection to determine which of the users may have a similar or related interest based on similar or overlapping taxonomy categories.

Content ranking unit 210 generates the content stream to be recommended to user 105 based on content, selected from content pool 135 based on the user's profile, as well as advertisement, selected by the advertisement insertion unit 200. The content to be recommended to the user 105 may also be determined, by the content ranking unit 210, based on information from the context information analyzer 170. For example, if a user is currently located in a beach town which differs from the zip code in the user's profile, it can be inferred that the user may be on vacation. In this case, information related to the locale where the user is currently in may be forwarded from the context information analyzer to the Content ranking unit 210 so that it can select content that not only fit the user's interests but also is customized to the locale. Other context information includes day, time, and device type. The context information can also include an event detected on the device that the user is currently using such as a browsing event of a website devoted to fishing. Based on such a detected event, the momentary interest of the user may be estimated by the context information analyzer 170, which may then direct the Content ranking unit 210 to gather content related to fishing amenities in the locale the user is in for recommendation.

The personalized content recommendation module 100 can also be configured to allow probing content to be included in the content to be recommended to the user 105, even though the probing content does not represent subject matter that matches the current known interests of the user. Such probing content is selected by the unknown interest explorer 215. Once the probing content is incorporated in the content to be recommended to the user, information related to user activities directed to the probing content (including no action) is collected and analyzed by the user event analyzer 175, which subsequently forwards the analysis result to long/short term interest identifiers 180 and 185. If an analysis of user activities directed to the probing content reveals that the user is or is not interested in the probing content, the user understanding unit 155 may then update the user profile associated with the probed user accordingly. This is how unknown interests may be discovered. In some embodiments, the probing content is generated based on the current focus of user interest (e.g., short term) by extrapolating the current focus of interests. In some embodiments, the probing content can be identified via a random selection from the general content, either from the content pool 135 or from the content sources 110, so that an additional probing can be performed to discover unknown interests.

To identify personalized content for recommendation to a user, the content ranking unit 210 takes all these inputs and identify content based on a comparison between the user profile vector and the content vector in a multiphase ranking approach. The selection may also be filtered using context information. Advertisement to be inserted as well as possibly probing content can then be merged with the selected personalized content.

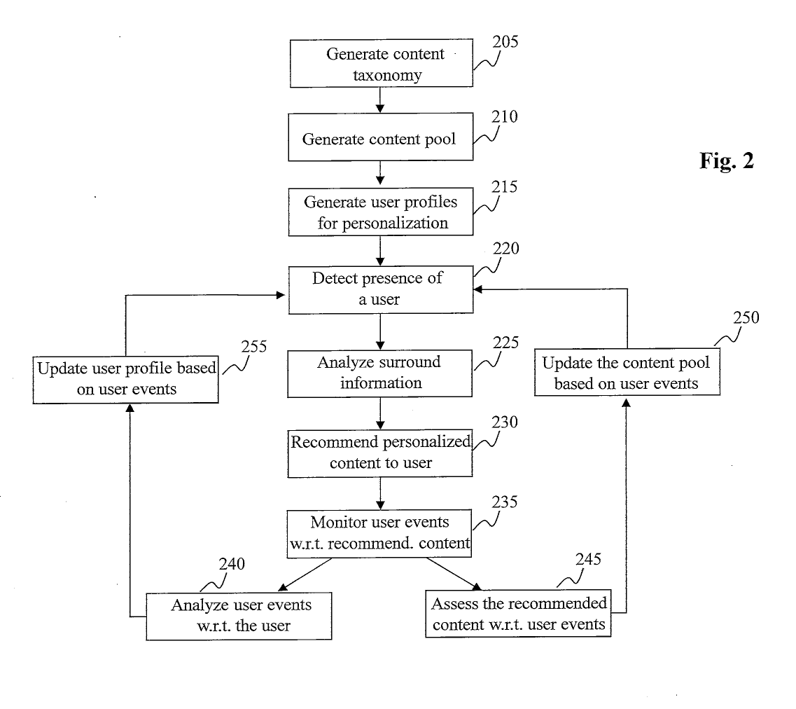

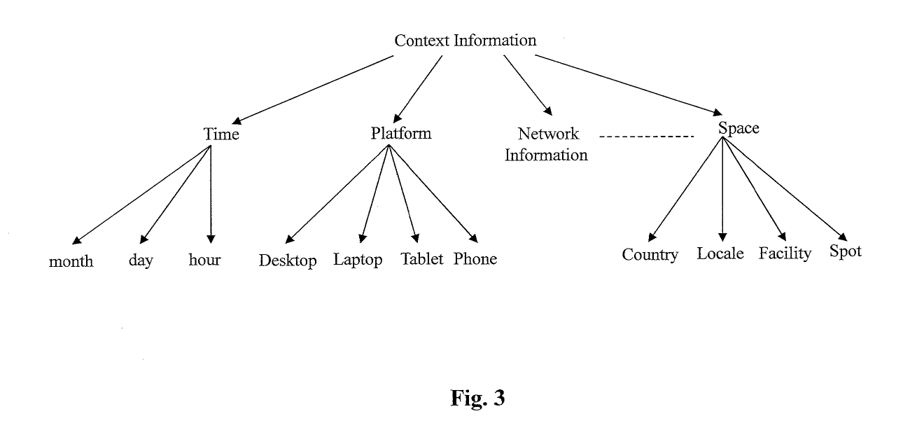

FIG. 2 is a flowchart of an exemplary process for personalized content recommendation, according to an embodiment of the present teaching. Content taxonomy is generated at 205. Content is accessed from different content sources and analyzed and classified into different categories, which can be pre-defined. Each category is given some labels and then different categories are organized into some structure, e.g., a hierarchical structure. A content pool is generated at 210. Different criteria may be applied when the content pool is created. Examples of such criteria include topics covered by the content in the content pool, the performance of the content in the content pool, etc. Sources from which content can be obtained to populate the content pool include content sources 110 or third party platforms 120 such as Facebook, Twitter, blogs, etc. FIG. 3 provides a more detailed exemplary flowchart related to content pool creation, according to an embodiment of the present teaching. User profiles are generated at 215 based on, e.g., user information, user activities, identified short/long term interests of the user, etc. The user profiles may be generated with respect to a baseline population interest profile, established based on, e.g., information about third party interest, knowledge archives, and content taxonomies.

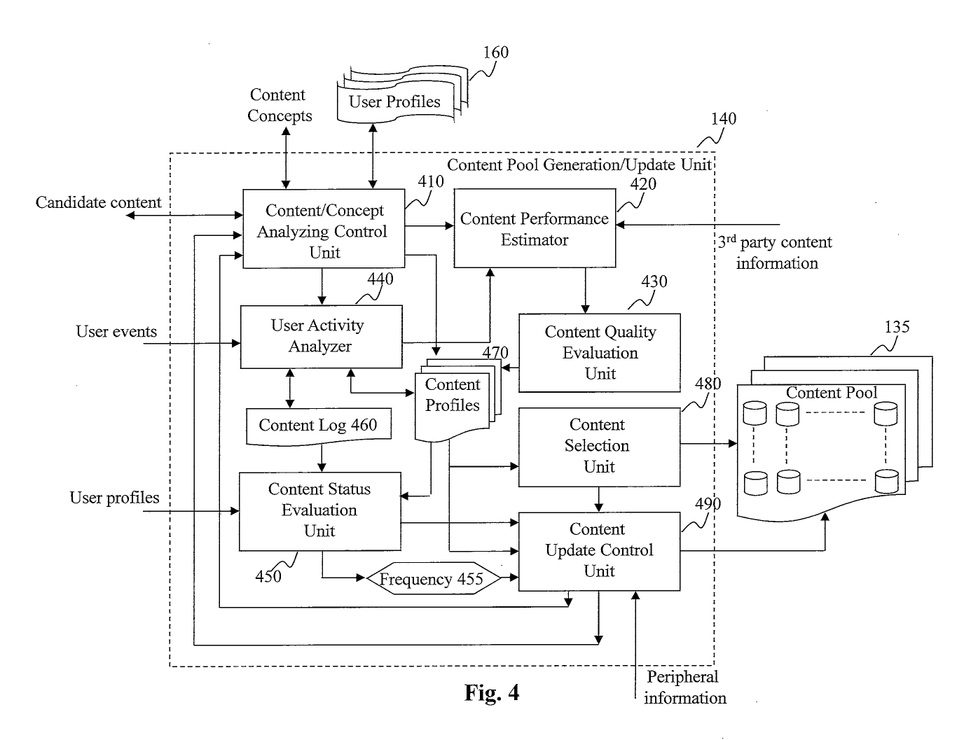

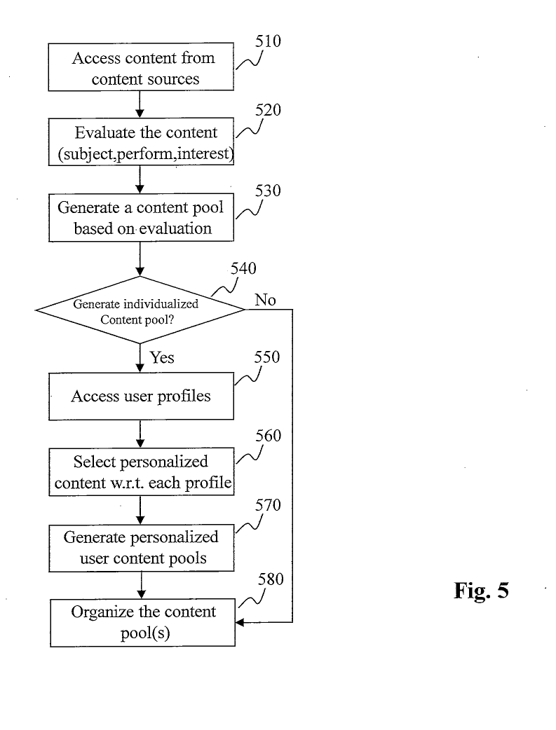

Once the user profiles and the content pool are created, when the system 10 detects the presence of a user, at 220, the context information, such as locale, day, time, may be obtained and analyzed, at 225. FIG. 4 illustrates exemplary types of context information. Based on the detected user's profile, optionally context information, personalized content is identified for recommendation. A high level exemplary flow for generating personalized content for recommendation is presented in FIG. 5. Such gathered personalized content may be ranked and filtered to achieve a reasonable size as to the amount of content for recommendation. Optionally (not shown), advertisement as well as probing content may also be incorporated in the personalized content. Such content is then recommended to the user at 230.

User reactions or activities with respect to the recommended content are monitored, at 235, and analyzed at 240. Such events or activities include clicks, skips, dwell time measured, scroll location and speed, position, time, sharing, forwarding, hovering, motions such as shaking, etc. It is understood that any other events or activities may be monitored and analyzed. For example, when the user moves the mouse cursor over the content, the title or summary of the content may be highlighted or slightly expanded. In another example, when a user interacts with a touch screen by her/his finger[s], any known touch screen user gestures may be detected. In still another example, eye tracking on the user device may be another user activity that is pertinent to user behaviors and can be detected. The analysis of such user events includes assessment of long term interests of the user and how such exhibited short term interests may influence the system's understanding of the user's long term interests. Information related to such assessment is then forwarded to the user understanding unit 155 to guide how to update, at 255, the user's profile. At the same time, based on the user's activities, the portion of the recommended content that the user showed interests are assessed, at 245, and the result of the assessment is then used to update, at 250, the content pool. For example, if the user shows interests on the probing content recommended, it may be appropriate to update the content pool to ensure that content related to the newly discovered interest of the user will be included in the content pool.

FIG. 3 illustrates different types of context information that may be detected and utilized in assisting to personalize content to be recommended to a user. In this illustration, context information may include several categories of data, including, but not limited to, time, space, platform, and network conditions. Time related information can be time of the year (e.g., a particular month from which season can be inferred), day of a week, specific time of the day, etc. Such information may provide insights as to what particular set of interests associated with a user may be more relevant. To infer the particular interests of a user at a specific moment may also depend on the locale that the user is in and this can be reflected in the space related context information, such as which country, what locale (e.g., tourist town), which facility the user is in (e.g., at a grocery store), or even the spot the user is standing at the moment (e.g., the user may be standing in an aisle of a grocery store where cereal is on display). Other types of context information includes the specific platform related to the user's device, e.g., Smartphone, Tablet, laptop, desktop, bandwidth/data rate allowed on the user's device, which will impact what types of content may be effectively presented to the user. In addition, the network related information such as state of the network where the user's device is connected to, the available bandwidth under that condition, etc. may also impact what content should be recommended to the user so that the user can receive or view the recommended content with reasonable quality.

FIG. 4 depicts an exemplary system diagram of the content pool generation/update unit 140, according to an embodiment of the present teaching. The content pool 135 can be initially generated and then maintained according to the dynamics of the users, content items, and needs detected. In this illustration, the content pool generation/update unit 140 comprises a content/concept analyzing control unit 410, a content performance estimator 420, a content quality evaluation unit 430, a content selection unit 480, which will select appropriate content to place into the content pool 135. In addition, to control how content is to be updated, the content pool generation/update unit 140 also includes a user activity analyzer 440, a content status evaluation unit 450, and a content update control unit 490,

The content/concept analyzing control unit 410 interfaces with the content crawler 150 (FIG. 1) to obtain candidate content that is to be analyzed to determine whether the new content is to be added to the content pool. The content/concept analyzing control unit 410 also interfaces with the content/concept analyzer 145 (see FIG. 1) to get the content analyzed to extract concepts or subjects covered by the content. Based on the analysis of the new content, a high dimensional vector for the content profile can be computed via, e.g., by mapping the concepts extracted from the content to the universal interest space, e.g., defined via Wikipedia or other content taxonomies. Such a content profile vector can be compared with user profiles 160 to determine whether the content is of interest to users. In addition, content is also evaluated in terms of its performance by the content performance estimator 420 based on, e.g., third party information such as activities of users from third party platforms so that the new content, although not yet acted upon by users of the system, can be assessed as to its performance. The content performance information may be stored, together with the content's high dimensional vector related to the subject of the content, in the content profile 470. The performance assessment is also sent to the content quality evaluation unit 430, which, e.g., will rank the content in a manner consistent with other pieces of content in the content pool. Based on such rankings, the content selection unit 480 then determines whether the new content is to be incorporated into the content pool 135.

To dynamically update the content pool 135, the content pool generation/update unit 140 may keep a content log 460 with respect to all content presently in the content pool and dynamically update the log when more information related to the performance of the content is received. When the user activity analyzer 440 receives information related to user events, it may log such events in the content log 460 and perform analysis to estimate, e.g., any change to the performance or popularity of the relevant content over time. The result from the user activity analyzer 440 may also be utilized to update the content profiles, e.g., when there is a change in performance. The content status evaluation unit 450 monitors the content log and the content profile 470 to dynamically determine how each piece of content in the content pool 135 is to be updated. Depending on the status with respect to a piece of content, the content status evaluation unit 450 may decide to purge the content if its performance degrades below a certain level. It may also decide to purge a piece of content when the overall interest level of users of the system drops below a certain level. For content that requires update, e.g., news or journals, the content status evaluation unit 450 may also control the frequency 455 of the updates based on the dynamic information it receives. The content update control unit 490 carries out the update jobs based on decisions from the content status evaluation unit 450 and the frequency at which certain content needs to be updated. The content update control unit 490 may also determine to add new content whenever there is peripheral information indicating the needs, e.g., there is an explosive event and the content in the content pool on that subject matter is not adequate. In this case, the content update control unit 490 analyzes the peripheral information and if new content is needed, it then sends a control signal to the content/concept analyzing control unit 410 so that it can interface with the content crawler 150 to obtain new content.

FIG. 5 is a flowchart of an exemplary process of creating the content pool, according to an embodiment of the present teaching. Content is accessed at 510 from content sources, which include content from content portals such as Yahoo!, general Internet sources such as web sites or FTP sites, social media platforms such as Twitter, or other third party platforms such as Facebook. Such accessed content is evaluated, at 520, as to various considerations such as performance, subject matters covered by the content, and how it fit users' interests. Based on such evaluation, certain content is selected to generate, at 530, the content pool 135, which can be for the general population of the system or can also be further structured to create sub content pools, each of which may be designated to a particular user according to the user's particular interests. At 540, it is determined whether user-specific content pools are to be created. If not, the general content pool 135 is organized (e.g., indexed or categorized) at 580. If individual content pools for individual users are to be created, user profiles are obtained at 550, and with respect to each user profile, a set of personalized content is selected at 560 that is then used to create a sub content pool for each such user at 570. The overall content pool and the sub content pools are then organized at 580.

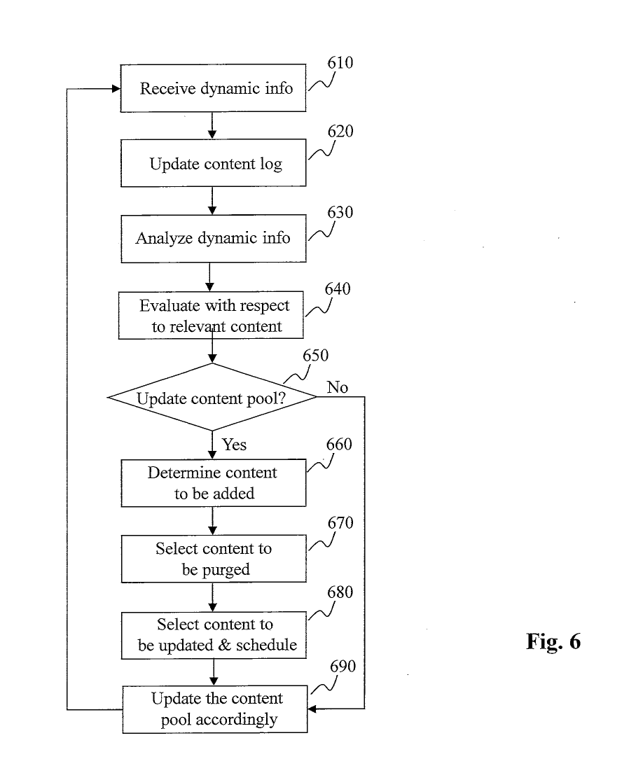

FIG. 6 is a flowchart of an exemplary process for updating the content pool 135, according to an embodiment of the present teaching. Dynamic information is received at 610 and such information includes user activities, peripheral information, user related information, etc. Based on the received dynamic information, the content log is updated at 620 and the dynamic information is analyzed at 630. Based on the analysis of the received dynamic information, it is evaluated, at 640, with respect to the content implicated by the dynamic information, as to the change of status of the content. For example, if received information is related to user activities directed to specific content pieces, the performance of the content piece may need to be updated to generate a new status of the content piece. It is then determined, at 650, whether an update is needed. For instance, if the dynamic information from a peripheral source indicates that content of certain topic may have a high demand in the near future, it may be determined that new content on that topic may be fetched and added to the content pool. In this case, at 660, content that needs to be added is determined. In addition, if the performance or popularity of a content piece has just dropped below an acceptable level, the content piece may need to be purged from the content pool 135. Content to be purged is selected at 670. Furthermore, when update is needed for regularly refreshed content such as journal or news, the schedule according to which update is made may also be changed if the dynamic information received indicates so. This is achieved at 680.

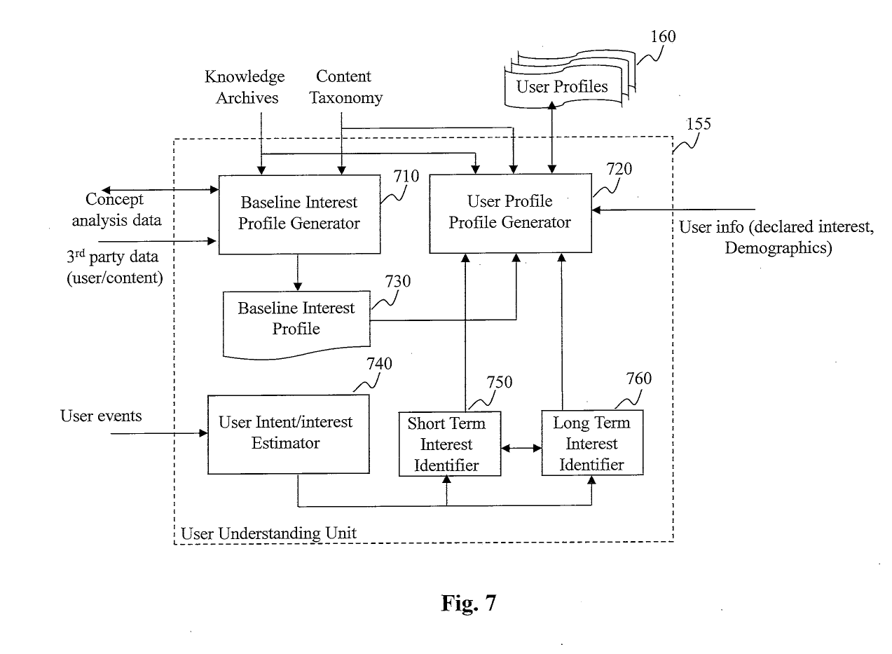

FIG. 7 depicts an exemplary diagram of the user understanding unit 155, according to an embodiment of the present teaching. In this exemplary construct, the user understanding unit 155 comprises a baseline interest profile generator 710, a user profile generator 720, a user intent/interest estimator 740, a short term interest identifier 750 and a long term interest identifier 760. In operation, the user understanding unit 155 takes various input and generates user profiles 160 as output. Its input includes third party data such as users' information from such third party platforms as well as content such users accessed and expressed interests, concepts covered in such third party data, concepts from the universal interest space (e.g., Wikipedia or content taxonomy), information about users for whom the personalized profiles are to be constructed, as well as information related to the activities of such users. Information from a user for whom a personalized profile is to be generated and updated includes demographics of the user, declared interests of the user, etc. Information related to user events includes the time, day, location at which a user conducted certain activities such as clicking on a content piece, long dwell time on a content piece, forwarding a content piece to a friend, etc.

In operation, the baseline interest profile generator 710 access information about a large user population including users' interests and content they are interested in from one or more third party sources (e.g., Facebook). Content from such sources is analyzed by the content/concept analyzer 145 (FIG. 1), which identifies the concepts from such content. When such concepts are received by the baseline interest profile generator 710, it maps such concepts to the knowledge archives 115 and content taxonomy 165 (FIG. 1) and generate one or more high dimensional vectors which represent the baseline interest profile of the user population. Such generated baseline interest profile is stored at 730 in the user understanding unit 155. When there is similar data from additional third party sources, the baseline interest profile 730 may be dynamically updated to reflect the baseline interest level of the growing population.

Once the baseline interest profile is established, when the user profile generator receives user information or information related to estimated short term and long term interests of the same user, it may then map the user's interests to the concepts defined by, e.g., the knowledge archives or content taxonomy, so that the user's interests are now mapped to the same space as the space in which the baseline interest profile is constructed. The user profile generator 720 then compares the user's interest level with respect to each concept with that of a larger user population represented by the baseline interest profile 730 to determine the level of interest of the user with respect to each concept in the universal interest space. This yields a high dimensional vector for each user. In combination with other additional information, such as user demographics, etc., a user profile can be generated and stored in 160.

User profiles 160 are updated continuously based on newly received dynamic information. For example, a user may declare additional interests and such information, when received by the user profile generator 720, may be used to update the corresponding user profile. In addition, the user may be active in different applications and such activities may be observed and information related to them may be gathered to determine how they impact the existing user profile and when needed, the user profile can be updated based on such new information. For instance, events related to each user may be collected and received by the user intent/interest estimator 740. Such events include that the user dwelled on some content of certain topic frequently, that the user recently went to a beach town for surfing competition, or that the user recently participated in discussions on gun control, etc. Such information can be analyzed to infer the user intent/interests. When the user activities relate to reaction to content when the user is online, such information may be used by the short term interest identifier 750 to determine the user's short term interests. Similarly, some information may be relevant to the user's long term interests. For example, the number of requests from the user to search for content related to diet information may provide the basis to infer that the user is interested in content related to diet. In some situations, estimating long term interest may be done by observing the frequency and regularity at which the user accesses certain type of information. For instance, if the user repeatedly and regularly accesses content related to certain topic, e.g., stocks, such repetitive and regular activities of the user may be used to infer his/her long term interests. The short term interest identifier 750 may work in connection with the long term interest identifier 760 to use observed short term interests to infer long term interests. Such estimated short/long term interests are also sent to the user profile generator 720 so that the personalization can be adapted to the changing dynamics.

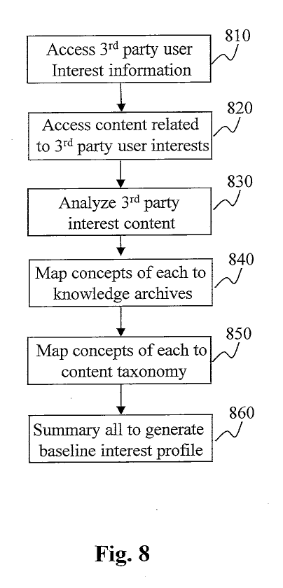

FIG. 8 is a flowchart of an exemplary process for generating a baseline interest profile based on information related to a large user population, according to an embodiment of the present teaching. The third party information, including both user interest information as well as their interested content, is accessed at 810 and 820. The content related to the third party user interests is analyzed at 830 and the concepts from such content are mapped, at 840 and 850, to knowledge archives and/or content taxonomy. To build a baseline interest profile, the mapped vectors for third party users are then summarized to generate a baseline interest profile for the population. There can be a variety ways to summarize the vectors to generate an averaged interest profile with respect to the underlying population.

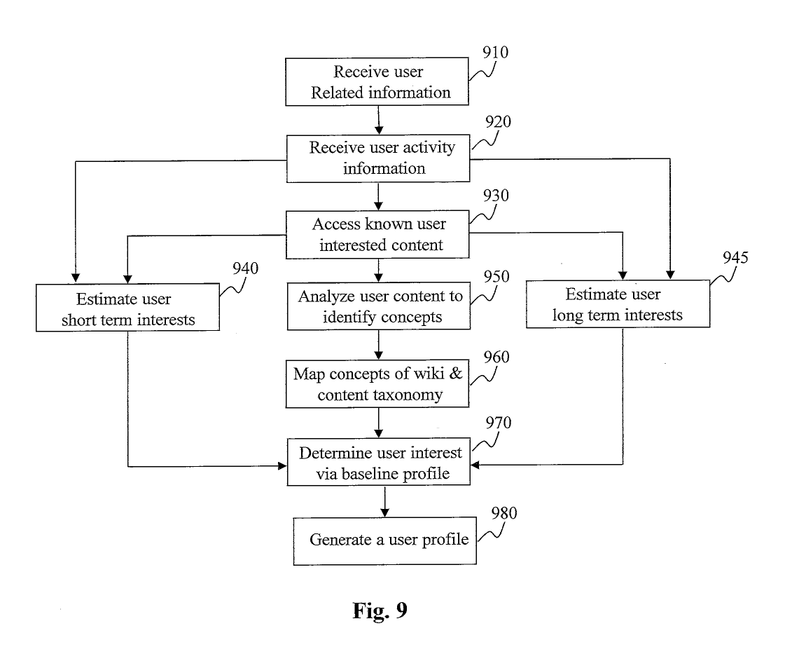

FIG. 9 is a flowchart of an exemplary process for generating/updating a user profile, according to an embodiment of the present teaching. User information is received first at 910. Such user information includes user demographics, user declared interests, etc. Information related to user activities is also received at 920. Content pieces that are known to be interested by the user are accessed at 930, which are then analyzed, at 950, to extract concepts covered by the content pieces. The extracted concepts are then mapped, at 960, to the universal interest space and compared with, concept by concept, the baseline interest profile to determine, at 970, the specific level of interest of the user given the population. In addition, the level of interests of each user may also be identified based on known or estimated short and long term interests that are estimated, at 940 and 945, respectively, based on user activities or content known to be interested by the user. A personalized user profile can then be generated, at 980, based on the interest level with respect to each concept in the universal interest space.

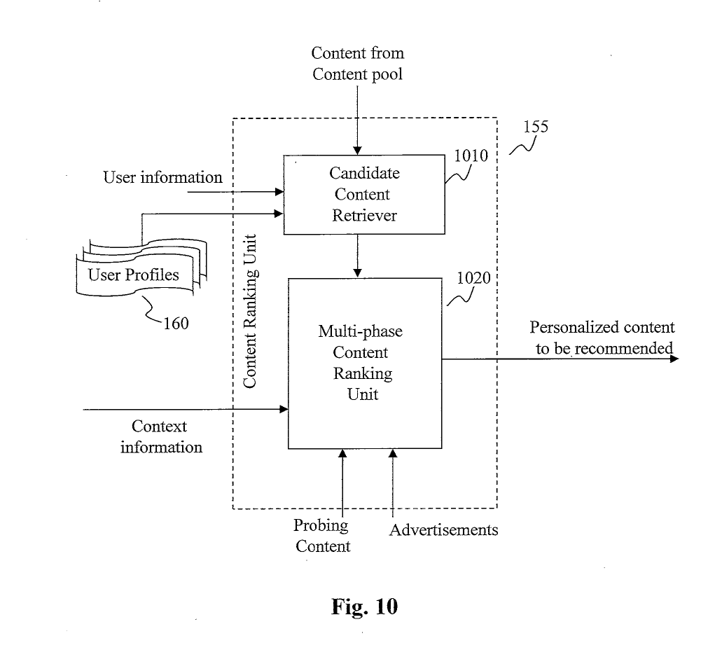

FIG. 10 depicts an exemplary system diagram for the content ranking unit 210, according to an embodiment of the present teaching. The content ranking unit 210 takes variety of input and generates personalized content to be recommended to a user. The input to the content ranking unit 210 includes user information from the applications 130 with which a user is interfacing, user profiles 160, context information surrounding the user at the time, content from the content pool 135, advertisement selected by the ad insertion unit 200, and optionally probing content from the unknown interest explorer 215. The content ranking unit 210 comprises a candidate content retriever 1010 and a multi-phase content ranking unit 1020. Based on user information from applications 130 and the relevant user profile, the candidate content retriever 1010 determines the content pieces to be retrieved from the content pool 135. Such candidate content may be determined in a manner that is consistent with the user's interests or individualized. In general, there may be a large set of candidate content and it needs to be further determined which content pieces in this set are most appropriate given the context information. The multi-phase content ranking unit 1020 takes the candidate content from the candidate content retriever 1010, the advertisement, and optionally may be the probing content, as a pool of content for recommendation and then performs multiple stages of ranking, e.g., relevance based ranking, performance based ranking, etc. as well as factors related to the context surrounding this recommendation process, and selects a subset of the content to be presented as the personalized content to be recommended to the user.

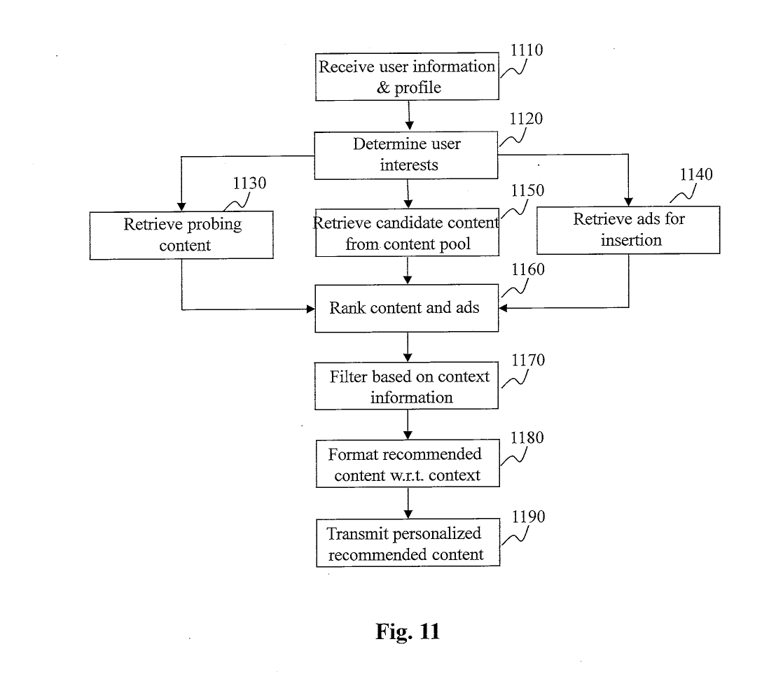

FIG. 11 is a flowchart of an exemplary process for the content ranking unit, according to an embodiment of the present teaching, User related information and user profile are received first at 1110. Based on the received information, user's interests are determined at 1120, which can then be used to retrieve, at 1150, candidate content from the content pool 135. The user's interests may also be utilized in retrieving advertisement and/or probing content at 1140 and 1130, respectively. Such retrieved content is to be further ranked, at 1160, in order to select a subset as the most appropriate for the user. As discussed above, the selection takes place in a multi-phase ranking process, each of the phases is directed to some or a combination of ranking criteria to yield a subset of content that is not only relevant to the user as to interests but also high quality content that likely will be interested by the user. The selected subset of content may also be further filtered, at 1170, based on, e.g., context information. For example, even though a user is in general interested in content about politics and art, if the user is currently in Milan, Italy, it is likely that the user is on vacation. In this context, rather than choosing content related to politics, the content related to art museums in Milan may be more relevant. The multi-phase content ranking unit 1020 in this case may filter out the content related to politics based on this contextual information. This yields a final set of personalized content for the user. At 1180, based on the contextual information associated with the surrounding of the user (e.g., device used, network bandwidth, etc.), the content ranking unit packages the selected personalized content, at 1180, in accordance with the context information and then transmits, at 1190, the personalized content to the user.

One of the major challenges in personalized content recommendation is to providing users a personalized experience by targeting them with content they more likely engage in. Traditionally, CTR has been the metric to optimize as a proxy to user interest and satisfaction. However, recommendation systems have started to realize that simply serving content that stimulates users' click impulse may not be the key to long term user satisfaction. Time spent is an important metric to measure user engagement on content, and is starting to be used as a proxy to user satisfaction, complementing and replacing CTR as a signal.

The present teaching acknowledges the fact that not all users may find the same content engaging. The present teaching aims to provide users a personalized experience by targeting them with content they more likely engage in. The method and system described in the present teaching use efficient machine learning methods, such as Bayesian sets, collaborative filtering, etc. for targeting users with highly engaging personalized content. The method and system detect users who are highly engaged in a particular content item and find similar users to target with that content. For example, the method and system may detect a set of users who dwell long on an article, use these users as “exemplars” to query the user pool to find similar users, and target these similar users with the same highly engaging article. Furthermore, for new users who also dwell long (i.e. are highly engaged in) on particular content item, the method and system can identify exemplar users who are also highly engaged in the same content item, and use their other engaging content for serving the new users. Content-level user engagement signals (metrics), such as per-content dwell time, can effectively differentiate engagement levels for each content item and each user; thus when used together with efficient machine learning techniques, the content recommendation systems can quickly and dynamically identify highly engaging articles (or other content types) and use the corresponding information to dynamically target similar users to provide better personalization experience.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

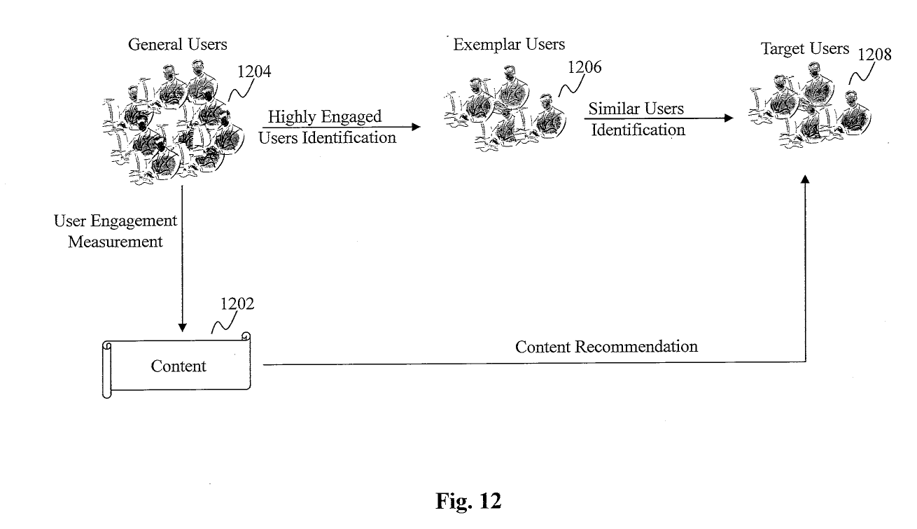

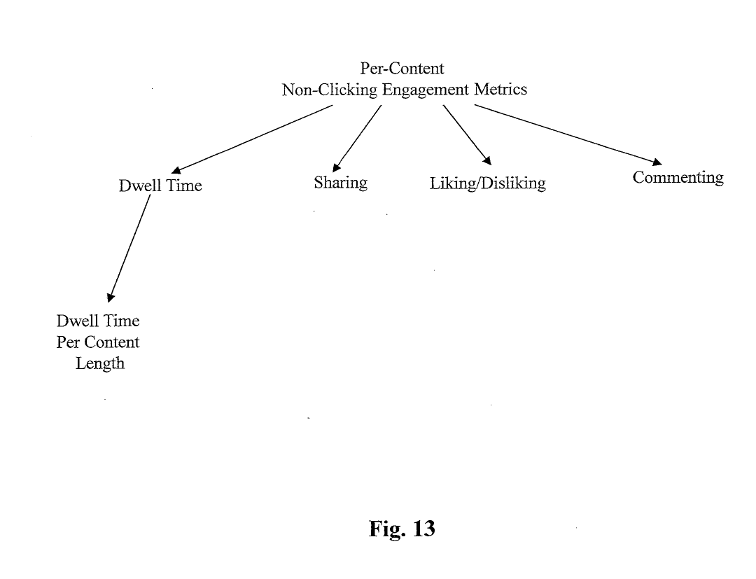

FIG. 12 depicts an exemplary scheme of the present teaching, according to an embodiment of the present teaching. In this embodiment, user engagement with respect to a particular piece of content 1202, e.g., an article, is continuously monitored for general users 1204. Various per-content user engagement signals (metrics) may be used for measuring the user engagement levels, such as dwell time, dwell time per content length, liking/disliking, commenting, sharing, etc., as shown in FIG. 13, Compared to click-based signals, per-content user engagement metrics described above can more effectively differentiate user engagement levels, thus more reliably identify highly engaged users (exemplar users 1206) for the content 1202. Being able to reliably identify exemplar users 1206 is critical for training machine learning models to identify other users who can be targeted (target users 1208). Exemplar users 1206 are identified from the general users 1204 who have interacted with the content 1202 based on the level of engagement with the content 1202. In other words, the exemplar users 1206 are users who highly engage in the content. Intuitively, the assumption is that higher user engagement level with respect to a piece of content, e.g., longer dwell time on an article, means higher user satisfaction. The exemplar users 1206 are then be used to query the user pool to find the similar users, i.e., target users 1208, and target them with the same highly engaging content 1202. In other words, it is assumed that the target users 1208 would have similar content consumption preferences as the exemplar users 1206, and thus, should be recommended with the same content 1202.

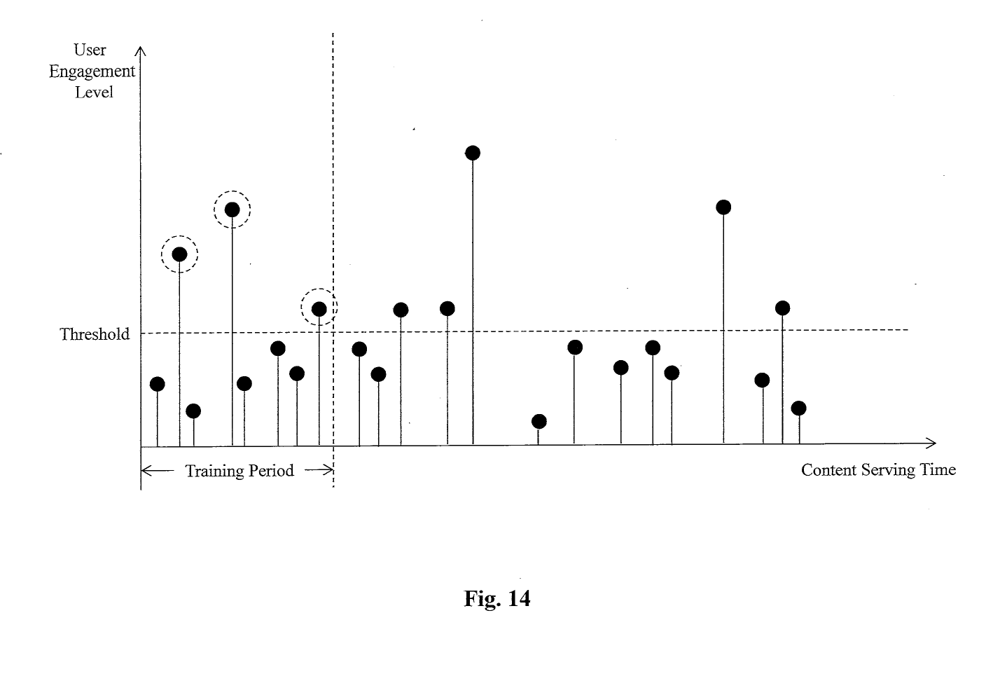

FIG. 14 depicts an exemplary diagram in which per-content user engagement events are ordered by timestamp and per-event user engagement levels are plotted on a timeline. Each data point in FIG. 14 indicates a user engagement event occurs when a user interacts with a particular piece of content. For example, a user reads an article by scrolling through the article is viewed as a user engagement event with respect to the article, and the length of the dwell time on the article is recorded by any suitable techniques, such as a web beacons, a cookie, or a tool bar embedded in the web browser. In this example, the height of each data point reflects the level of user engagement for each user engagement event, e.g., the length of the dwell time. It is understood that for some types of user engagement metrics, e.g., liking/disliking, the data points may become binary signals, e.g., 1 or 0. A threshold level of user engagement may be predetermined and used as a reference in selecting the highly engaged users with respect to the particular piece of content. In this example, a training period may be preset as well to select the exemplar users. In one example, the training time period may be half an hour or a few hours. All the user engagement events within the training time period are measured, and their levels are compared against the threshold. All the users whose measured metrics are above the threshold are identified as the exemplar users. It is understood that in other examples, instead of fixing the length of the training time period, the total number of users to be included in the exemplar users set is preset, and the training process continues until enough exemplar users have been identified regardless of the elapsed time,

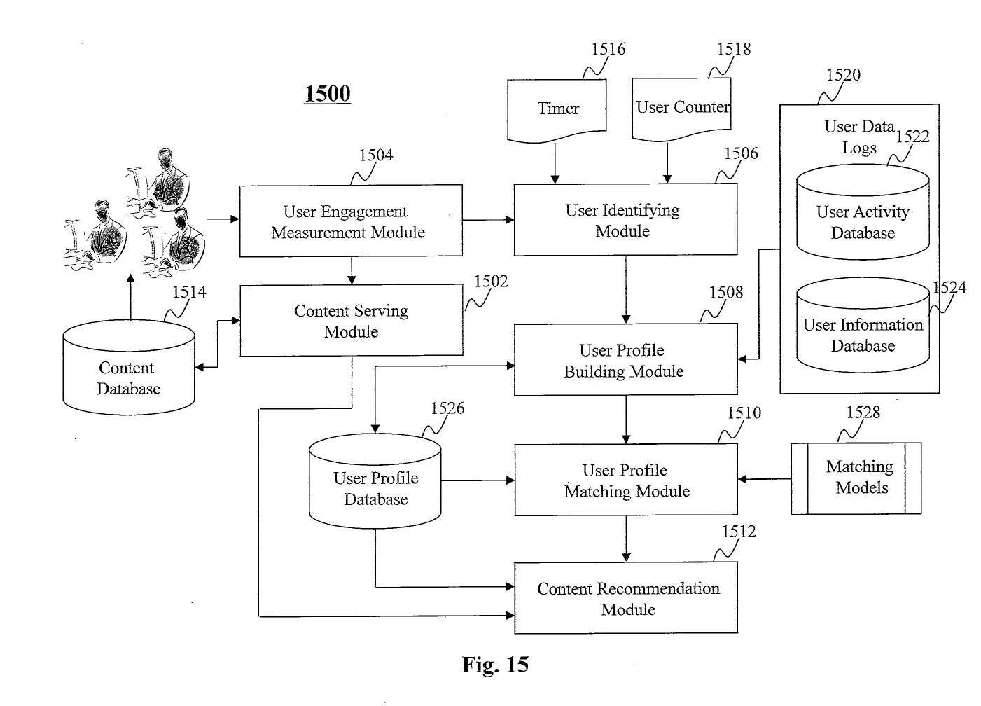

FIG. 15 is an exemplary system diagram for providing engaging content to targeted users, according to an embodiment of the present teaching. In this embodiment, the system 1500 includes a content serving module 1502, a user engagement measurement module 1504, a user identifying module 1506, a user profile building module 1508, a user profile matching module 1510, and a content recommendation module 1512. The content serving module 1502 is configured to server content from a content database 1514 to different users. For example, personalized content stream may be continuously served to users by the content serving module 1502, The user engagement measurement module 1504 is responsible for monitoring the user interactions with the served content, including any user engagement events. For example, the user engagement measurement module 1504 may measure a particular metric, e.g., dwell time, with respect to a content item for each of the users and feed the measured metrics to the user identifying module 1506. The user identifying module 1506 is configured for identifying all highly engaged users with respect to the particular content item based on their measured metrics and a threshold in order to form a set of exemplar users for the content item. A timer 1516 and/or a user counter 1518 may be included in the system 1500 to set the training time and/or the number of exemplar users to be identified. For example, the user identifying module 1506 may identify all the users who spend more than one minute in reading a specific article within the next three hours, or identify the next 100 users who spend more than one minute in reading the article.

In this embodiment, the user profile building module 1508 is configured to obtain user profiles of the identified exemplar users based on, for example, existing user profile database 1526 or user data logs 1520. For example, some or all of the exemplar users may already have their user profiles stored in the user profile database 1526, and the user profile building module 1508 may retrieve the corresponding user profiles. If there are no existing user profiles for certain exemplar users, the user profile building module 1508 is responsible for creating them as described before. In one example, the user profile building module 1508 uses known approaches, e.g. sparse polarity model or term frequency-inverse document frequency (TF-IDF) model, based on their reading activity from a previous long-time window (e.g. 1 month) stored in a user activity database 1522 and the users' personal information (e.g. age, gender, device type etc.) from a user information database 1524. Once a new user profile is created by the user profile building module 1508, the new user profile may be stored in the user profile database 1526 for future use. The user profile matching module 1510 is then responsible for retrieve similar users (target users) from the user profile database 1526 for targeting based on the user profiles of the exemplar users. Various matching models 1528 that relate to a degree of similarity across a plurality of user profiles may be applied to retrieve the similar users, including for example model-based set expansion approach (e.g., Bayesian sets), k-nearest neighbors approach, memory or model based collaborative filtering, lookalike models, or rule-based behavioral targeting approach, to name a few. The content recommendation module 1512 is responsible for providing the particular content item to some or all of the target users who have been identified by the user profile matching module 1510.

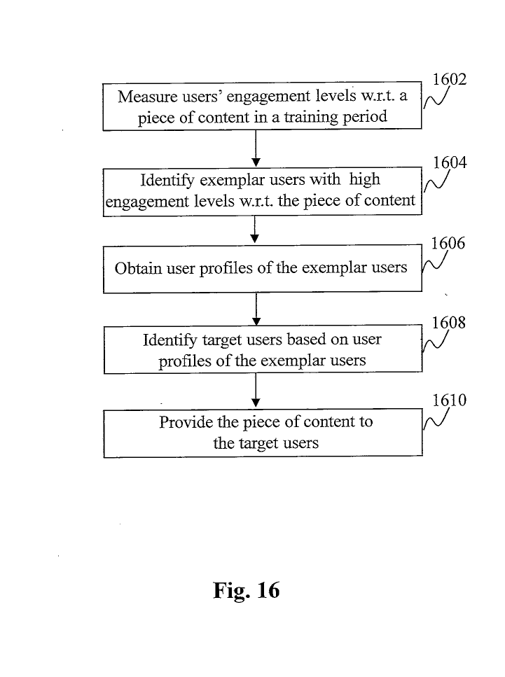

FIG. 16 is a flowchart of an exemplary process of the scheme shown in FIG. 12, according to an embodiment of the present teaching. The process first determines a set of highly engaged users for particular content item and then groups those highly engaged users for each content item and uses them as the exemplars to retrieve similar users who can be targeted using the same content item. Starting at 1602, users' engagement levels with respect to a piece of content are measured in a training period. The engagement levels may be measured in any suitable metrics, such as any of the per-content non-clicking engagement metrics illustrated in FIG. 13, Those metrics, such as per-content dwell time, can effectively differentiate engagement levels for each content item and each user, and thus can reliably identify highly engaged users for each content item. The training period may be a relative short time window, e.g., half an hour or a few hours, compared with the entire content server period. In one example, the content items are presented to users continuously in content streams, and metrics of each user for each content item in the content stream are measured.

At 1604, exemplar users with high engagement levels with respect to the piece of content are identified from all the users who have received the piece of content in the training period based on their measured metrics. A threshold may be used to differentiate those highly engaged users from general users. For metrics like dwell time, the threshold may be a specific value of the dwell time that is adjusted for the particular content item. In one example, the dwell time distribution of the content item for all users in the training period is obtained, and a comparable user engagement level score is calculated for each read event and user who reads that article. The z-value in the log(dwelltime+1) space is calculated for each read event. If the z-value is larger than the threshold, this user is identified as a highly engaged user for the article. For binary metrics like liking/disliking, the threshold may be one of the two possible outcomes, e.g., all the users who “liked” the article are deemed as the highly engaged users for the article.

At 1606, user profiles of the exemplar users are obtained. The user profiles may be retrieved from previous records if they are in place or may be built using various approaches as described before or known in the art based on user's personal information and/or online user activities. Moving to 1608, target users who have the similar content consumption preferences as the exemplar users are identified based on the user profiles of the exemplar users. A model that relates to a degree of similarity across a plurality of user profiles may be used for matching target users with the exemplar users. For example, user profiles that are similar to the user profiles of the exemplar user are determined based on the model, and users who have the determined user profiles are identified as the target users. At 1610, the particular piece of content is provided to the identified target users as a personalized content recommendation.

In one example, the model includes a memory-based collaborative filtering approach. In this example, a user-content matrix is used for retrieving users to be served with a particular content item. The user-content matrix is constructed based on the measured metrics that relate to user engagement levels. Note that this will be a sparse matrix to start with, and the aim is to predict the missing entries of this matrix to decide which users to target with what content item. For example, the content items are represented as vectors of engagement by different users. For a given content item of interest, nearest neighbors of this content item (the content items with most similar engagement levels by the all users who have an engagement score) is retrieved. Users who have high estimated levels of engagement are targeted. In another example, the model includes a model-based collaborative filtering approach. Matrix factorization using latent variables is an example of this class of models. This is computationally more expensive than the memory-based collaborative filtering, but is more robust to noise. Similar to memory-based collaborative filtering, matrices are constructed using engagement levels as described above. In still another example, the model includes a k-nearest neighbors approach. In this example, given a set of users highly engaged in a content item (exemplar users), top-k most similar users, based on cosine similarity or Jaccard-index-based similarity measures, can be targeted with that content item. This approach is similar to memory-based collaborative filtering methods, but is more general since the feature vector representation of users is not limited to the engagement level matrix, but can also be any representation that summarizes the attributes of users, including but not limited to demographic information, user profiles built from previous reading activity, user profiles built from activities. In yet another example, the model includes a model-based set expansion approach, such as Bayesian sets. This model learns how important or representative each feature is from the exemplar user set and gives a score to the test cases depending on their feature vectors weighted by these importance weights. The ideas in set expansion or query by example are also applicable here. These approaches require a small set of seed examples and the desired output is a target set of users. A particular user may belong to many different seed sets, as the sets of users who find different items engaging may be overlapping but not necessarily not identical. In addition, the model may also include the rule-based behavioral targeting approach or the lookalike model. For example, classifiers are trained using positive labeled data (users who are highly engaged in a particular content item, e.g. users who dwell significantly longer than the general users who read this article) and negative labeled data (users who are not highly engaged in the content item).

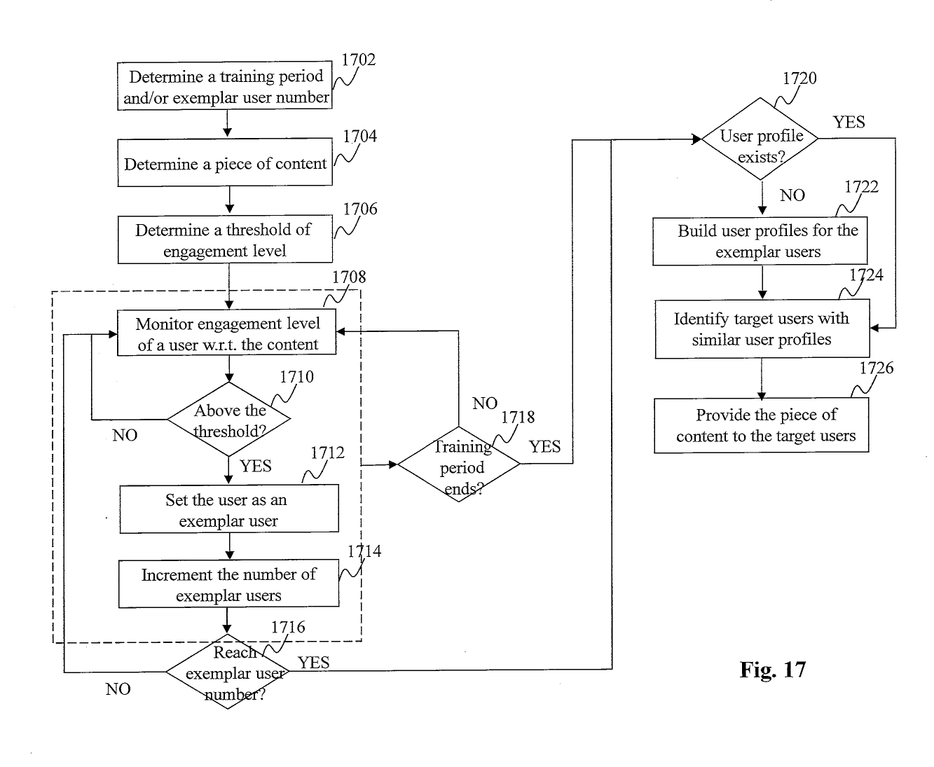

FIG. 17 is a flowchart of another exemplary process of the scheme shown in FIG. 12, according to an embodiment of the present teaching. As the method and system of the present teaching can leverage limited user engagement signals on a particular content item to discover users who have similar reading interest from a broad audience and target them with the same or similar content, the training period and/or the number of user profiles may be set to be relative small so as to achieve quick and dynamic targeting. Starting at 1702, a training period and/or the number of exemplar users are determined. At 1704, the particular piece of content of interest, e.g., an article, a news report, a video clip, etc., is determined. At 1706, a threshold of engagement level is determined based on the specific content item (e.g., the type or length of the content item) and/or the metrics to be measured (e.g., dwell time based metrics or binary metrics).

Moving to 1708, a metric relating to user engagement level with respect to the content item is monitored for each user. At 1710, each measured metric is compared against the threshold. If the measured metric is not above the threshold, the process returns back to 1708 to continue monitoring the next engagement event. Otherwise, the process continues to 1712, where the user whose measured metric is above the threshold is set as one of the exemplar users. The total number of exemplar users is incremented at 1714. At 1716, the current number of exemplar users is checked to see if it has reached the preset number of exemplar users. If not, the process returns back to 1708 to continue monitoring the next engagement event. Otherwise, the process moves to 1720. Additionally or alternatively, the length of the training period is checked at 1718 against the preset value to determine if the training process returns back to 1708 to measure the next engagement event or moves to 1720. At 1720, whether the user profiles of the exemplar users exist is checked. If not, at 1722, user profiles for the exemplar user are built using any suitable approaches described above or as known in the art. If the user profiles exist, they are retrieved and used to identify target users with similar user profiles at 1724 based on a model as described above. At 1726, the particular piece of content is provided to the target users as a recommended personalized content.

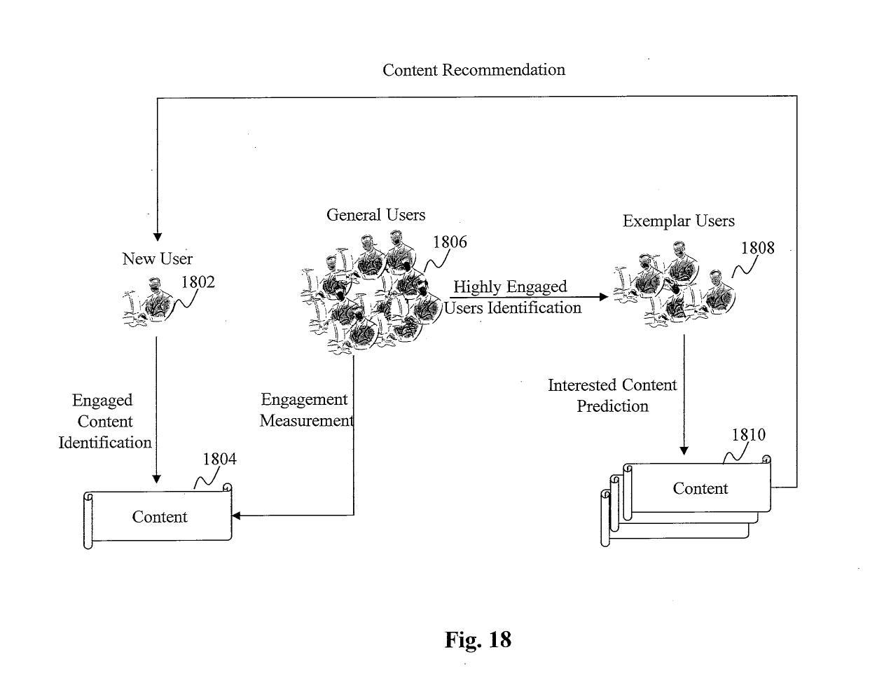

FIG. 18 depicts another exemplary scheme of the present teaching, according to an embodiment of the present teaching. In this embodiment, for each new user 1802 who is interested in a content item 1804, e.g., reaching a dwell threshold on a particular article after finding exemplar users who 1808 have demonstrated the similar interest (e.g., also dwell long on that article); the user profiles of those similar engaged users 1808 are used to recommend content for this new user 1802. This scheme can effectively and efficiently address the cold start problem with a new user 1802: first leveraging the new user's 1802 limited online activities to identify the content 1804 in which the user has engaged in a short-time window, and then measuring engagement levels with respect to the content item 1804 for general users 1806 to identify exemplar users set 1808 of the engaging content item, and building plausible inferred user profile for the new user 1802. The newly built inferred user profile can be directly used for recommending other content items 1810 to the new user 1802.

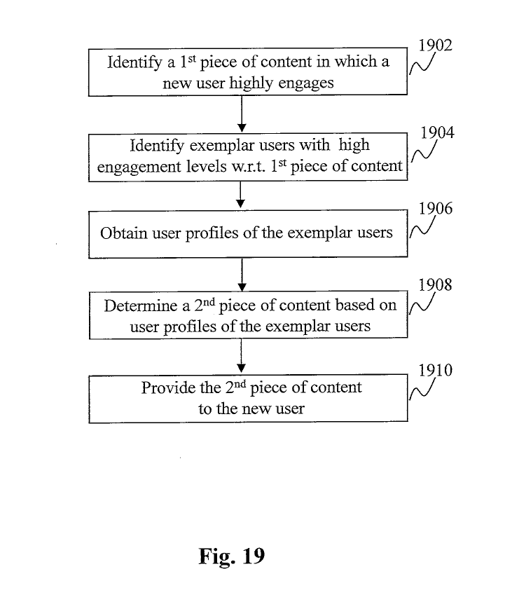

FIG. 19 is a flowchart of an exemplary process of the scheme shown in FIG. 18, according to an embodiment of the present teaching. Starting at 1902, a first piece of content in which the target user (e.g., a new user whose information is limited) is interested in is identified. For example, the first piece of content may be identified from a plurality pieces of content in which the target user has engaged. Engagement levels with respect to each piece of content in which the user has engaged are obtained by measuring a suitable metric. The content item with the highest engagement level is then identified as the first piece of content. At 1904, exemplar users with high engagement levels with respect to the first piece of content are identified. As described above, a metric with respect to the first piece of content is measured for each of the users who have been presented with the first piece of content in a training period, and the exemplar users are identified by comparing their measured metrics against a threshold. At 1906, use profiles of the exemplar users are obtained. Moving to 1908, a second piece of content is determined based on the user profiles of the exemplar users. Any suitable approaches known in the art for identifying content based on user profiles may be used at 1908. The second piece of content is then provided to the target user (new user) as recommended personalized content at 1910. For example, user profile information obtained at 1906 may be used to compute an average user profile for the new user, so that the new user can be served with content item(s) that matches the average user profile. The underlying assumption here is that users who are highly engaged in the same content could have the same content consumption preference.

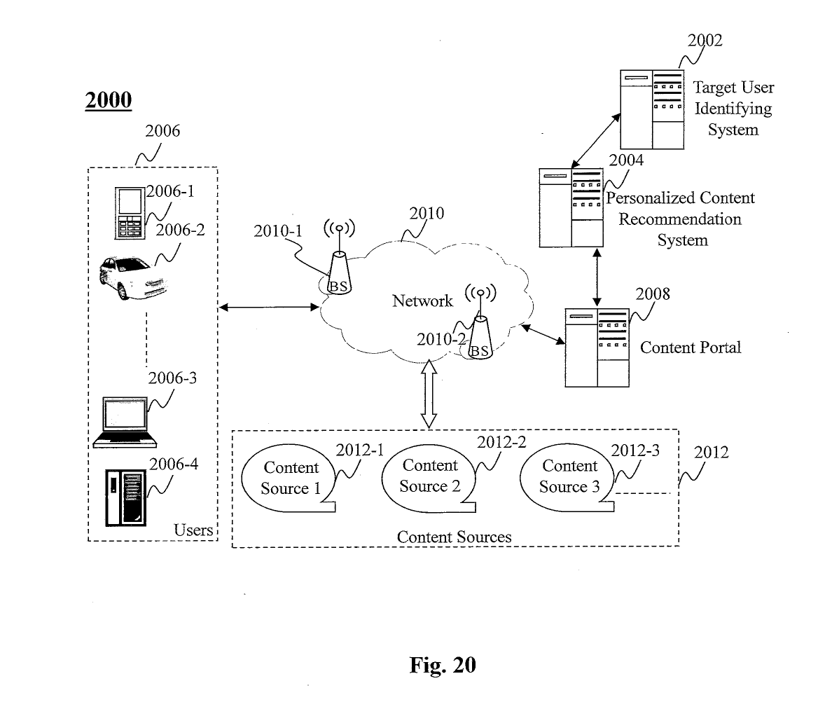

FIGS. 20-22 depict exemplary embodiments of a networked environment in which the present teaching is applied, according to different embodiments of the present teaching. In FIG. 20, an exemplary networked environment 2000 includes a target user identifying system 2002, a personalized content recommendation system 2004, users 2006, a content portal 2008, a network 2010, and content sources 2012. The network 2010 may be a single network or a combination of different networks. For example, the network 2010 may be a local area network (LAN), a wide area network (WAN), a public network, a private network, a proprietary network, a Public Telephone Switched Network (PSTN), the Internet, a wireless network, a virtual network, or any combination thereof. The network 2010 may also include various network access points, e.g., wired or wireless access points such as base stations or Internet exchange points 2010-1, 2010-2, through which a data source may connect to the network 2010 in order to transmit information via the network 2010.

Users 2006 may be of different types such as users connected to the network 2010 via different user devices, for example, a desktop computer 2006-4, a laptop computer 2006-3, a mobile device 2006-1, or a built-in device in a motor vehicle 2006-2. A user 2006 may send a request and provide basic user information to the content portal 2008 (e.g., a search engine, a social media website, etc.) via the network 2010 and receive personalized content streams from the content portal 2008 through the network 2010. Once the content streams are provided to the users 2006, the users 2006 may further interact with the content by any explicitly or implicitly actions as described in the present teaching. The personalized content recommendation system 2004 in this example may work as backend support of the content portal 2008 for recommending personalized content to the user 2006. In this example, the target user identifying system 2002 may also serve as backend support of the personalized content recommendation system 2004. The target user identifying system 2002 may be implemented as the system 1500 described above for targeting of users with engaging content. The target user identifying system 2002 then provides information related to the target users and their engaging content to the personalized content recommendation system 2004 for content recommendation.

The content sources 2012 include multiple third-party content sources 2012-1, 2012-2, 2012-3. A content source may correspond to a website hosted by an entity, whether an individual, a business, or an organization such as USPTO.gov, a content provider such as cnn.com and facebook.com, or a content feed source such as Twitter or blogs. The personalized content recommendation system 2004 may access any of the content sources 2012-1, 2012-2, 2012-3 to obtain information related to the users 2006 to construct user profiles and/or collect content to build its content pool. For example, the personalized content recommendation system 2004 may fetch content, e.g., websites, through its crawler.

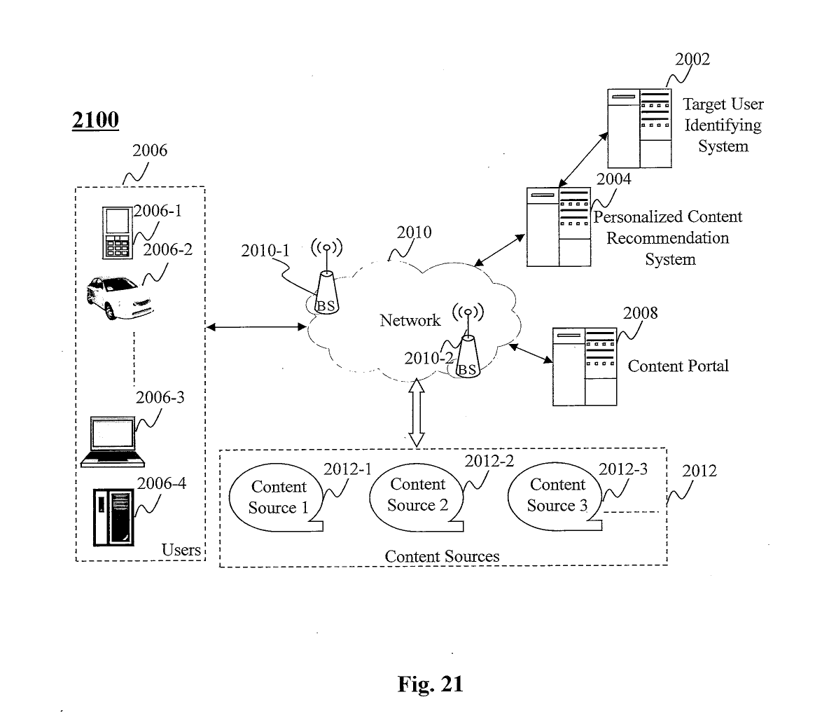

FIG. 21 presents a similarly networked environment as what is shown in FIG. 20 except that the personalized content recommendation system 2004 is configured as an independent service provider that interacts with the users 2006 directly to provide personalized content recommendation service. In the exemplary networked environment 2100, the personalized content recommendation system 2004 may receive a request with some basic information from a user 2006 and provide personalized content streams to the user 2006 directly without going through a third-party content portal 2008.

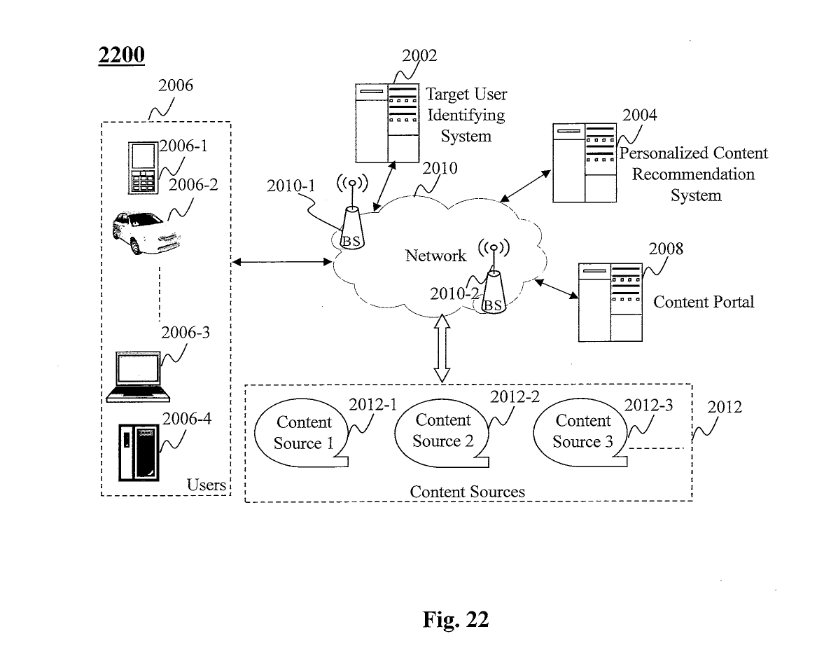

FIG. 22 presents a similarly networked environment as what is shown in FIG. 21 except that the target user identifying system 2002 in the exemplary networked environment 2200 is also configured as an independent service provider to provide information related to target users and their engaging content for personalized content recommendation.

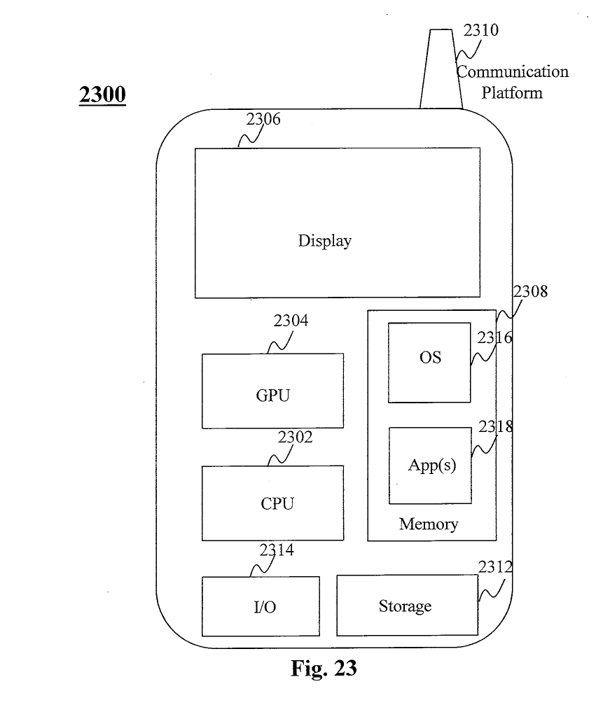

FIG. 23 depicts a general mobile device architecture on which the present teaching can be implemented. In this example, the user device on which personalized content is presented is a mobile device 2300, including but is not limited to, a smart phone, a tablet, a music player, a handled gaming console, a global positioning system (GPS) receiver. The mobile device 2300 in this example includes one or more central processing units (CPUs) 2302, one or more graphic processing units (GPUs) 2304, a display 2306, a memory 2308, a communication platform 2310, such as a wireless communication module, storage 2312, and one or more input/output (I/O) devices 2314. Any other suitable component, such as but not limited to a system bus or a controller (not shown), may also be included in the mobile device 2300. As shown in FIG. 23, a mobile operating system 2316, e.g., iOS, Android, Windows Phone, etc., and one or more applications 2318 may be loaded into the memory 2308 from the storage 2312 in order to be executed by the CPU 2302. The applications 2318 may include a browser or any other suitable mobile apps for receiving and rendering personalized content streams on the mobile device 2300. Execution of the applications 2318 may cause the mobile device 2300 to perform some processing as described above. For example, the display of personalized content to the user may be made by the GPU 2304 in conjunction with the display 2306. User interactions with the personalized content stream may be achieved via the I/O devices 2314 and provided to the system 1500 via the communication platform 2310.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

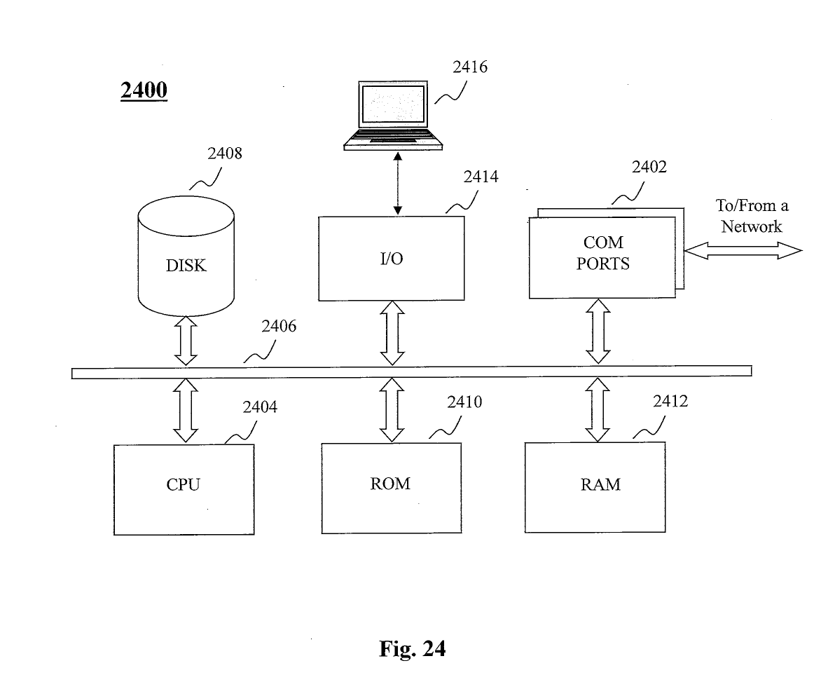

FIG. 24 depicts a general computer architecture on which the present teaching can be implemented and has a functional block diagram illustration of a computer hardware platform that includes user interface elements. The computer may be a general-purpose computer or a special purpose computer. This computer 2400 can be used to implement any components of the targeted user content recommendation architecture as described herein. Different components of the system in the present teaching can all be implemented on one or more computers such as computer 2400, via its hardware, software program, firmware, or a combination thereof. Although only one such computer is shown, for convenience, the computer functions relating to the target metric identification may be implemented in a distributed fashion on a number of similar platforms, to distribute the processing load.

The computer 2400, for example, includes COM ports 2402 connected to and from a network connected thereto to facilitate data communications. The computer 2400 also includes a central processing unit (CPU) 2404, in the form of one or more processors, for executing program instructions. The exemplary computer platform includes an internal communication bus 2406, program storage and data storage of different forms, e.g., disk 2408, read only memory (ROM) 2410, or random access memory (RAM) 2412, for various data files to be processed and/or communicated by the computer, as well as possibly program instructions to be executed by the CPU 2404. The computer 2400 also includes an I/O component 2414, supporting input/output flows between the computer and other components therein such as user interface elements 2416. The computer 2400 may also receive programming and data via network communications,

Hence, aspects of the method of providing content to targeted users, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution. In addition, the components of the system as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine, each of which has at least one processor, storage, and a communication platform connected to a network for providing content, the method comprising the steps of:
measuring a metric with respect to a piece of content for each of a plurality of users;
identifying a first set of users from the plurality of users based on the measured metrics and a threshold;
obtaining user profiles of the first set of users;
identifying a second set of users based on the user profiles of the first set of users; and
providing the piece of content to the second set of users.

2. The method of claim 1, wherein the metric relates to a user's level of engagement with respect to the piece of content.

3. The method of claim 1, wherein the step of identifying a first set of users comprises:
determining a length of time for identifying the first set of users; and
identifying each of users whose measured metric is above the threshold within the length of time.

4. The method of claim 1, wherein the step of identifying a first set of users comprises:
determining the number of users in the first set of users; and
identifying each of users whose measured metric is above the threshold until the number of identified users reaches the determined number of users in the first set of users.

5. The method of claim 1, wherein each of the user profiles is obtained based on personal information and/or online activities of the corresponding user in the first set of users.

6. The method of claim 1, wherein the step of identifying a second set of users comprises:
determining one or more user profiles that are similar to the user profiles of the first set of users based on a model that relates to a degree of similarity across a plurality of user profiles; and
identifying users having the determined one or more user profiles.

7. A method implemented on at least one machine, each of which has at least one processor, storage, and a communication platform connected to a network for providing content, the method comprising the steps of:
identifying a first piece of content in which a target user is interested;
measuring a metric with respect to the first piece of content for each of a plurality of users;
identifying a set of users from the plurality of users based on the measured metrics and a threshold;
obtaining user profiles of the set of users;
determining a second piece of content based on the user profiles of the set of users; and
providing the second piece of content to the target user.

8. The method of claim 7, wherein the first piece of content is identified from a plurality pieces of content in which the target user has engaged.

9. The method of claim 7, wherein the second piece of content is determined based on an average user profile obtained from the user profiles of the set of users.

10. A system having at least one processor, storage, and a communication platform for providing content, the system comprising:
a user engagement measurement module implemented by the at least one processor and configured to measure a metric with respect to a piece of content for each of a plurality of users;
a user identifying module implemented by the at least one processor and configured to identify a first set of users from the plurality of users based on the measured metrics and a threshold;
a user profile building module implemented by the at least one processor and configured to obtain user profiles of the first set of users;
a user profile matching module implemented by the at least one processor and configured to identify a second set of users based on the user profiles of the first set of users; and
a content recommendation module implemented by the at least one processor and configured to provide the piece of content to the second set of users.

11. The system of claim 10, wherein the metric relates to a user's level of engagement with respect to the piece of content.

12. The system of claim 10, wherein the user identification module is further configured to:
determine a length of time for identifying the first set of users; and
identify each of users whose measured metric is above the threshold within the length of time.

13. The system of claim 10, wherein the user identification module is further configured to:
determine the number of users in the first set of users; and
identify each of users whose measured metric is above the threshold until the number of identified users reaches the determined number of users in the first set of users.

14. The system of claim 10, wherein each of the user profiles is obtained based on personal information and/or online activities of the corresponding user in the first set of users.

15. The system of claim 10, wherein the user profile matching module is further configured to:
determine one or more user profiles that are similar to the user profiles of the first set of users based on a model that relates to a degree of similarity across a plurality of user profiles; and
identify users having the determined one or more user profiles.

16. A non-transitory machine-readable medium having information recorded thereon for providing content, wherein the information, when read by the machine, causes the machine to perform the following:
measuring a metric with respect to a piece of content for each of a plurality of users;
identifying a first set of users from the plurality of users based on the measured metrics and a threshold;
obtaining user profiles of the first set of users;
identifying a second set of users based on the user profiles of the first set of users; and
providing the piece of content to the second set of users.

17. The medium of claim 16, wherein the metric relates to a user's level of engagement with respect to the piece of content.

18. The medium of claim 16, wherein the step of identifying a first set of users comprises:
determining a length of time for identifying the first set of users; and
identifying each of users whose measured metric is above the threshold within the length of time.

19. The medium of claim 16, wherein the step of identifying a first set of users comprises:
determining the number of users in the first set of users; and
identifying each of users whose measured metric is above the threshold until the number of identified users reaches the determined number of users in the first set of users.

20. The medium of claim 16, wherein each of the user profiles is obtained based on personal information and online activities of the corresponding user in the first set of users.
